(19) United States
(12) Patent Application Publication
(10) Pub. No.: US 2026/0361698 A1
(43) Pub. Date: Nov. 12, 2026

(54) SCALABLE MODULAR SECURE NETWORK SYSTEM, ARCHITECTURE AND SECURE NETWORK MODULE THEREFOR

(71) Applicant: CRYPTO4A TECHNOLOGIES INC., Ottawa, Ontario (CA)

(72) Inventors: Bruno COUILLARD, Gatineau, Québec (CA); James Ross GOODMAN, Ottawa, Ontario (CA); Jean-Pierre FISET, Ottawa, Ontario (CA); Brian ELDRIDGE, Stittsville, Ontario (CA); John O'CONNOR, Carleton Place, Ontario (CA)

(21) Appl. No.: 19/489,125

(22) PCT Filed: May 30, 2024
(86) PCT No.: PCT/CA2024/050724

§ 371 Date: Dec. 1, 2025

Related U.S. Application Data
(60) Provisional application No. 63/469,764, filed on May 30, 2023.

(51) Int. Cl. H04L 9/40; H04L 9/32

(52) U.S. Cl. CPC H04L 63/0428; H04L 9/321

(57) ABSTRACT

Described are various embodiments of a scalable modular secure network system, architecture, and secure network module therefor. In one example, a modular network security system comprises a cradle defining a plurality of juxtaposed network module slots having a cradle slot interface to an integrated cradle communication network; and a plurality of network modules each comprising a corresponding cradle network interface. At least one of the network modules comprises a cryptographic processor hardwired therein to operatively interface with the corresponding cradle network interface to cryptographically secure communications between at least some of the modules over the integrated cradle communication network.

### FIELD OF THE DISCLOSURE

The present disclosure relates to secure network systems, and, in particular, to a scalable modular secure network system, architecture and secure network module therefor.

### BACKGROUND

The provision, customization and management of secure network infrastructure is an ongoing challenge in the provision of secure, accurate and reliable network services and resources, for example, as there is an ongoing and increasing desire for such services and resources.

As one example, hardware security modules (HSM) are known to provide a physical computing device that safeguards and manages digital keys for digital system authentication and cryptographic processing. For example, HSMs routinely form part of mission-critical infrastructures such as public key infrastructures or online banking applications. These modules traditionally come in the form of a plug-in card, or an external device that attaches directly to a computer or network server.

In external device implementations, a hardware processor and storage device is provided within a tamper-resistant casing or the like so to minimize unauthorized access and hardware tampering, while also occasionally providing tamper evidence logging. An external input/output interface is provided via PCMCIA (Personal Computer Memory Card International Association), PC Card interface, Smart Card interface, USB port, or any other communication interface that may be design specific and that links to an internal memory used for storing private keys and like data in an associated key space, and a cryptographic engine for processing these keys for an intended purpose (authentication and/or authorization, encryption/decryption, etc.). A PCI or PCIe (Peripheral Component Interconnect Express) interface can alternatively be provided to result in a similar implementation.

In network implementations, a network attached HSM may take the form of a standard HSM communicatively linked to an appliance server (e.g., an integrated HMS PCIe card may interface internally via an application layer interface to the appliance server) or the like that intermediates access to the HSM and can thus allow a same network attached HSM to interface with distinct services. For instance, HSM access software executed on the appliance server can sort through various inbound requests received from distinct network-accessible sources and channels and manage processing of such requests by the HSM over a singular server-HSM channel. Ultimately, the HSM is executed in response to the appliance server and thus generally remains blind to the sorting and management functions of the appliance server.

The SafeNet Luna SA/Network HSM (Gemalto, Belcamp, MD, e.g. see https://safenet.gemalto.com/data-encryption/hardware-security-modules-hsms/safenet-network-hsm/) provides one example of a network HSM in which multiple HSM hardware storage partitions can be defined to secure corresponding cryptographic keys. These keys are stored to service corresponding network applications via an onboard access software that provides the network linking services on the appliance, that executes programmed logic to interface with the partitioned key spaces on one side, and the various network applications on the other via corresponding secured network connections (i.e. SSL). Accordingly, a common HSM network interface can be used to concurrently service various network applications or clients over respective secure network connections thereto, while also providing partitioned storage solutions to store application-specific keys in distinct storage partitions.

A few of the HSMs available in the market today have the ability to execute specially developed modules within the HSM's secure enclosure. Such ability is useful, for example, in cases where special algorithms or business logic has to be executed in a secured and controlled environment. For example, HSMs provided by Thales e-Security (Plantation, FL, e.g. see https://www.thales-esecurity.com/products-and-services/products-and-services/hardware-security-modules) promote the ability to host critical applications within the HSM's security boundary so to establish tamper-resistant business processes (i.e. executed within a generally anti-tamper running environment) in addition to protecting cryptographic operations.

U.S. Patent Application publication No. 2013/0219164 describes Cloud-Based Hardware Security Modules in which a cloud-based HSM provides core security functions of a physically controlled HSM, such as a USB HSM, while allowing user access within the cloud and from a user device, including user devices without input ports capable of direct connection to the HSM. The HSMs can be connected to multi-HSM appliances on the organization or user side of the cloud network, or on the cloud provider side of the cloud network. HSMs can facilitate multiple users, and multi-HSM appliances can facilitate multiple organizations.

International Application publication No. WO 2016/099644 describes Systems and Methods for Using Extended Hardware Security Modules that possess additional security properties relative to conventional HSMs and methods for initializing, deploying, and managing such extended HSMs in a networked environment. An extended HSM is described to generally include additional hardware and software components that configure it to run sensitive client tasks on demand inside a cloud-hosted, anti-tamper HSM housing so as to ensure sensitive data is encrypted when stored or processed outside the housing. By deploying virtualization technology inside the extended HSM, virtual HSMs may be implemented as virtual machines or more efficient light-weight operating system-level virtualized containers. As such, a single extended HSM host may run one or more virtualized extended HSM guests in respective virtualized spaces. Namely, a host HSM may provide a virtual network interface functionality to a guest using its underlying hardware network interface to implement the provided network interface functionality.

Furthermore, multi-level network architectures are commonly deployed, for instance, where disparate networking resources are required to establish particular network data paths across and particularly between network zones and/or interfaces in order to deliver a particular service or application. Physical separation between network resources is also commonplace in high security implementations, for example, where physically isolated network security zones may be required to secure back end resources for instance deployed in a high security zone from public and/or low security authorized user zones. In some high security installations, the establishment of physically isolated networking devices/appliances is in fact a requirement to satisfy security compliance standards beyond basic commercial networking standards, such as described in the Federal Information Processing Standard (FIPS 140-2) document published by the United States National Institutes of Standards and Technology (NIST), for example, and above. Accordingly, a network security zoning architecture may be invoked to physically separate a high security zone in which a sensitive restricted-access database or application server is implemented, from a public access zone operated in accordance with reduced access security standards so to allow greater user access and operation.

Generally, a multi-level network architecture, such as a network security zoning architecture, will take the form of a stack of distinct network-enabled devices, interconnected in accordance with a designated operational network design via a series of corresponding physical network interface controllers and cables, to relay data, commands and instructions over a set of established (secured) data channels. In doing so, reasonable security strength can be achieved by virtue of the respective physical segregation of the externally interconnected networking devices, though network tampering may nonetheless result from physical reconnection of the subject devices, unauthorized local access via external physical connection to one or more of the subject devices, introduction of an unauthorized hacking device, or again by unauthorized reallocation of software-defined ports and/or data channels on tampered or otherwise compromised devices, to name a few examples. It is therefore considered critical to also ensure the physical security of such architectures.

Alternative solutions to physically segregated network devices may include the virtualization of certain network resources through software so as to combine multiple such resources on a same networking device or appliance. Accordingly, rather than to physically interconnect networking devices as above, a set of virtual network interface controllers may be configured in software to define appropriate virtual interfaces between the various network components virtualized on a same physical device. In the context of network security zoning, system designers may seek to at least partially collapse a given network zoning architecture into one or more virtualization zones (e.g. physically segregated zone-by-zone virtualization or physically aggregated zone virtualizations—see for example, Network Segmentation in Virtualized Environments by vmware: https://www.vmware.com/content/dam/digitalmarketing/vmware/en/pdf/techpaper/network_segmentation.pdf). Contrary to its physical implementation, a virtualized zoning architecture will interconnect virtualized servers via virtual switches, network interface controllers and the like to reduce required hardware. In doing so, the system becomes easier to implement and customize through software management applications, but also becomes more vulnerable to misconfigurations of, or tampering with, the virtualized system components, which may result in loss of zone isolations and/or data breaches.

This background information is provided to reveal information believed by the applicant to be of possible relevance. No admission is necessarily intended, nor should be construed, that any of the preceding information constitutes prior art or forms part of the general common knowledge in the relevant art.

### SUMMARY

The following presents a simplified summary of the general inventive concept(s) described herein to provide a basic understanding of some aspects of the disclosure. This summary is not an extensive overview of the disclosure. It is not intended to restrict key or critical elements of embodiments of the disclosure or to delineate their scope beyond that which is explicitly or implicitly described by the following description and claims.

A need exists for a scalable modular secure network system, architecture, and secure network module therefor, that overcome some of the drawbacks of known techniques, or at least, provides a useful alternative thereto. Some aspects of this disclosure provide examples of such systems, devices, modules and related processes.

In accordance with one aspect, there is provided a modular network security system, comprising: a cradle, dimensioned to define a plurality of juxtaposed network module slots, each comprising at a terminal end thereof, a cradle slot interface to an integrated cradle communication network; a plurality of network modules dimensioned to mount juxtaposed within respective network module slots and each comprising a corresponding cradle network interface such that, when a given network module is mounted within a given network cradle slot, said corresponding cradle network interface physically engages said cradle slot interface thereby communicatively interfacing said given network module with said integrated cradle communication network; wherein each of said network modules comprises a cryptographic processor operatively interfacing with said corresponding cradle network interface to cryptographically secure communications between said modules over said integrated cradle communication network.

In accordance with one aspect, there is provided a modular network security system, comprising: a cradle, dimensioned to define a plurality of juxtaposed network module slots, each comprising at a terminal end thereof, a cradle slot interface to an integrated cradle communication network; a plurality of network modules dimensioned to mount juxtaposed within respective network module slots and each comprising a corresponding cradle network interface such that, when a given network module is mounted within a given network cradle slot, said corresponding cradle network interface physically engages said cradle slot interface thereby communicatively interfacing said given network module with said integrated cradle communication network; wherein at least one of said network modules comprises a cryptographic processor hardwired therein to operatively interface with said corresponding cradle network interface to cryptographically secure communications between at least some of said modules over said integrated cradle communication network.

In accordance with one embodiment, the at least one of said network modules comprises a network module processing engine to execute a dedicated module-specific process, and wherein said cryptographic processor thereof operatively interfaces between said network module processing engine and said corresponding cradle network interface so to cryptographically secure said dedicated module-specific process from distinct network module processes.

In accordance with one embodiment, the at least one of said network modules comprises an external network interface and an external network module processing engine operable to execute an external network interfacing process that exchanges external network communications with said cryptographic processor for cryptographic processing prior to engagement with said integrated cradle network.

In accordance with one embodiment, the integrated cradle network comprises a cradle agent operable to monitor operation of each of said network module via each said cradle slot interface.

In accordance with one embodiment, upon mounting a new network module to interface with said integrated cradle network, said cryptographic processor of said new network module is operable to communicate with said cryptographic processor of other network modules interfacing with said integrated cradle network to establish secure communications therewith.

In accordance with one embodiment, the secure communications are established with said new network module upon at least one of said other network modules cryptographically authenticating of said new network module.

In accordance with one embodiment, the new network module executes a cryptographic self-identification process with said other network modules.

In accordance with one embodiment, each of said modules is further powered via said cradle slot interface.

In accordance with one embodiment, the cradle is configured to hold a horizontal stack of vertically oriented network modules, wherein said horizontal stack is dimensioned to correspond with 2 or more network rack units.

In accordance with one embodiment, the horizontal stack is dimensioned to correspond with 3 network rack units.

In accordance with one embodiment, the cradle is mountable to or within a communication network rack or cabinet.

In one embodiment, the cradle is configured to hold a horizontal stack of juxtaposed horizontally oriented network modules, wherein said horizontal stack is dimensioned to correspond with one or more network rack units.

In one embodiment, the cradle is configured to hold a horizontal stack of vertically oriented network modules, and further hold one or more horizontally oriented network modules horizontally disposed above or below said horizontal stack.

In one embodiment, the plurality of network modules comprise distinct network module types respectively hardwired to provide, in operation, a distinct dedicated function, wherein, in combination, said plurality of network modules communicatively cooperate via said cradle communication network to perform a common network solution.

In one embodiment, the at least one of said network modules comprising said cryptographic processor defines a network security module, whereas at least one of said distinct network module types comprises a network module processing engine to execute a dedicated module-specific process that defines a network computation module that relies on implementation of said cryptographic processor from said network security module, via said integrated cradle communication network, to execute required cryptographic processes for said module-specific process.

In one embodiment, the at least one of said network modules is hardwired to define a time synchronization module that comprises integrated therein a precision timing device and a given cryptographic processor operable to securely provide a digitally trusted time resource via said cradle network to at least another of said network modules.

In one embodiment, the at least one of said network modules is hardwired to define a geo-positioning module that comprises integrated therein a Global Positioning System component and a given cryptographic processor operable to securely provide a digitally trusted geo-position to the modular network security system.

In one embodiment, the cryptographic processor is operatively couple to said at least one of said network modules via a hardware integrated PCIe card.

In one embodiment, the system further comprises a management module having a management engine hardwired therein and a cradle network interface to operatively interface with said plurality of network modules via said cradle communication network.

In one embodiment, the system comprises two said management module each comprising an external network interface to respectively define a control plane and a data plane, while further defining a restricted plane for communications amongst said plurality of network modules via said cradle network.

In accordance with another aspect, there is provided a modular network security system, comprising: a cradle, dimensioned to define a plurality of horizontally juxtaposed network module slots; and a plurality of network modules dimensioned to mount (vertically oriented and) horizontally juxtaposed within respective network module slots, at least two of said network modules comprising a network interface, an integrated processing engine, and an integrated cryptographic processor operable to execute a cryptographic process on communications exchanged with said integrated processing engine.

In accordance with one embodiment, the plurality of network modules, when mounted vertically oriented and horizontally juxtaposed within said cradle, are dimensioned to correspond with 2 or more network rack units.

In accordance with one embodiment, the plurality of network modules, when mounted vertically oriented and horizontally juxtaposed within said cradle, are dimensioned to correspond with 3 network rack units.

In accordance with one embodiment, the cradle further comprises an integrated physical cradle network, and wherein each of said network modules is operable to digitally communicate with one another over said cradle network.

In accordance with one embodiment, the network modules communicate cryptographically with one another over said cradle network via their respective cryptographic processor.

In accordance with one embodiment, at least one said integrated processing engine executes a network attached host process.

In accordance with one embodiment, the cryptographic processor comprises a hardware security module.

In accordance with another aspect, there is provided a secure network module, comprising: a housing mountable side-by-side juxtaposed horizontally with other corresponding network modules operatively mounted to a common server rack within a same rack unit; a network interface operatively disposed on a front face of said housing to interface with an external network cable connector therein; an integrated processing engine operatively mounted within said casing and interfacing via said network interface to process external network communications; and an integrated cryptographic processor operatively mounted within said casing to interface with said integrated processing engine and execute a cryptographic process on internal communications exchanged with said integrated processing engine.

In accordance with one embodiment, when mounted vertically oriented to the common server rack, is dimensioned to correspond with 2 or more network rack units.

In accordance with one embodiment, when mounted vertically oriented to the common server rack, is dimensioned to correspond with 3 network rack units.

In accordance with one embodiment, the secure network module further comprises a rack network interface operatively disposed on a rear face of said housing to interface with a corresponding secure hardwired rack network when operatively mounted to digitally communicate with said other corresponding network modules.

In accordance with one embodiment, the cryptographic processor is operable to communicates cryptographically with said other network modules over said secure hardwired rack network.

In accordance with one embodiment, the integrated processing engine executes a network attached host process.

In accordance with one embodiment, the cryptographic processor comprises a hardware security module.

In accordance with one embodiment, the secure network module further comprises a GPS chip operatively hardwired to said processing engine and operable to provide a trusted location of the module and/or said other network modules.

In accordance with one embodiment, the secure network module further comprises a secure timing device operatively hardwired to said processing engine and operable to provide a trusted time for the module and/or said other network modules.

In accordance with one embodiment, the housing comprises a vertically mountable housing mountable in a vertical orientation.

Other aspects, features and/or advantages will become more apparent upon reading of the following non-restrictive description of specific embodiments thereof, given by way of example only with reference to the accompanying drawings.

### BRIEF DESCRIPTION OF THE FIGURES

Several embodiments of the present disclosure will be provided, by way of examples only, with reference to the appended drawings, wherein:

FIG. 1 is a schematic diagram of a secure network module operable to interface with an external network, in accordance with one embodiment;

FIG. 2 is a schematic diagram of a secure network module as in FIG. 1, adapted for internal operation without direct external network access, in accordance with one embodiment;

FIG. 3 is a schematic diagram of an illustrative hardware security module (HSM) operable as a security processor in the secure network module of FIG. 1 or 2, in accordance with one embodiment;

FIG. 4 is a schematic diagram of an alternative hardware security module (HSM) operable as a security processor in the secure network module of FIG. 1 or 2, in accordance with another embodiment;

FIG. 5 is a schematic diagram of scalable assembly of secure network modules, such as that illustrated in FIG. 1, each operable to interface with a respective external network connection, in accordance with one embodiment;

FIG. 6 is a schematic diagram of a scalable assembly of secure network modules, such as those illustrated in FIGS. 1 and 2, in which only a first of the modules is operable to interface directly with an external network whereas downstream modules are operatively shielded from this external network interface by the first module, in accordance with one embodiment;

FIG. 7 is a schematic diagram of a cradle operable to interconnect a plurality of secure network modules while providing access to an integrated distinctly network-interfaceable cradle agent, in accordance with one embodiment;

FIG. 8 is a schematic diagram of the scalable assembly of secure network modules as illustrated in FIG. 5, operatively mounted to the cradle as illustrated in FIG. 7, in accordance with one embodiment;

FIG. 9 is a schematic diagram of the scalable assembly of secure network modules as illustrated in FIG. 6, operatively mounted to the cradle as illustrated in FIG. 7, in accordance with one embodiment;

FIG. 10 is a high-level schematic representation of a Cross-Domain Solution (CDS), in accordance with one embodiment, assembled from a series of secure network modules, as illustratively depicted in FIGS. 1 and 2, operatively mounted within a cradle such as that illustratively depicted in FIG. 7;

FIG. 11A is a perspective view of a secure network module, whereas FIG. 11B is a top plan view thereof, FIG. 11C is a side view thereof, and FIGS. 11D and 11E are front and rear elevation views thereof respectively, in accordance with one embodiment;

FIG. 12 is perspective internal schematic view of the secure network module of FIG. 11A, in accordance with one embodiment;

FIGS. 13A and 13B are front and back perspective views of a single module desktop chassis having a single secure network module operatively received therein, in accordance with one embodiment;

FIGS. 13C, 13D, 13E and 13F are top plan, side, front and rear elevation views, respectively, of the single module desktop chassis of FIGS. 13A and 13B;

FIG. 14 is a perspective view of a 10-module chassis having a set of 10 secure network modules operatively mounted therein and operatively interfacing with an integrated cradle thereof that can be operatively mounted or assembled to correspond with a 3-rack unit (3RU) space in a standard server rack, in accordance with one embodiment

FIG. 15 is a perspective view of a 12-module chassis having a set of 12 secure network modules operatively mounted therein and operatively interfacing with an integrated cradle thereof that can be operatively mounted or assembled to correspond with a 3-OpenRack U (3OU) space in a larger server rack, in accordance with one embodiment;

FIGS. 16A and 16B are perspective and front side views of a 3-module chassis having a set of 3 horizontally disposed secure network modules operatively mounted therein and operatively interfacing with an integrated cradle thereof that can be operatively mounted or assembled to correspond with a 1-rack unit (1RU) space in a standard sever rack, in accordance with one embodiment;

FIG. 17A is a schematic diagram of a scalable assembly of secure network modules, comprising in this example, a dual quantum assured security blade module, in accordance with one embodiment;

FIG. 17B is a schematic diagram of scalable assembly in which a dual quantum assured security blade module, as show for example in FIG. 17A, is combined with a secure network module operable to interface with an external network, as shown for example in FIG. 1, in accordance with one embodiment;

FIG. 17C is a schematic diagram of the scalable assembly of secure network modules as illustrated in FIG. 17B, operatively mounted to the cradle as illustrated in FIG. 7, in accordance with one embodiment;

FIG. 18 is a schematic diagram of a scalable assembly of secure network modules, comprising in this example, a time synchronization blade module, in accordance with one embodiment;

FIG. 19 is a schematic diagram of a scalable assembly of secure network modules, comprising in this example, a geolocation synchronization blade module, in accordance with one embodiment;

FIG. 20 is a schematic diagram of a scalable assembly of secure network modules, comprising in this example, a network switch blade module, in accordance with one embodiment;

FIG. 21 is a schematic diagram of a scalable assembly of secure network modules, comprising in this example, a network blade module integrating a processing engine and a Peripheral Component Interconnect Express (PCIe) card, in accordance with one embodiment;

FIG. 22 is a schematic diagram of a scalable assembly of secure network modules, comprising in this example, a network blade module integrating two PCIe cards interconnected by a PCIe bridge, in accordance with one embodiment;

FIG. 23 is a schematic diagram of a scalable assembly of secure network modules, comprising in this example, a dual compute blade module comprising two hardware integrated and segregated processing engines, in accordance with one embodiment;

FIG. 24 is a schematic diagram of a secure network module operable as a smart chassis management module and having an integrated management engine, in accordance with one embodiment;

FIG. 25A is a schematic diagram of another secure network module operable as a smart chassis management module, in this embodiment combining integrated and communicatively linked management engine and network switch processor;

FIG. 25B is a schematic diagram of a pair of the smart chassis management modules of FIG. 25, operatively mounted to a cradle as illustrate in FIG. 7, in accordance with one embodiment;

FIG. 25C is a schematic diagram of the pair of smart chassis management modules operatively mounted to the cradle as illustrate in FIG. 25B, and further illustrating the operative mounting of a scalable assembly of secure network modules, such as that illustrated in FIG. 5, in accordance with one embodiment; and

FIG. 26 is a schematic diagram of a smart chassis assembly maintaining segregated Control and Data Planes, in accordance with one embodiment.

Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiments are often not depicted in order to facilitate a less obstructed view of these various embodiments of the present disclosure.

### DETAILED DESCRIPTION

Various implementations and aspects of the specification will be described with reference to details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

Various apparatuses and processes will be described below to provide examples of implementations of the system disclosed herein. No implementation described below limits any claimed implementation and any claimed implementations may cover processes or apparatuses that differ from those described below. The claimed implementations are not limited to apparatuses or processes having all of the features of any one apparatus or process described below or to features common to multiple or all of the apparatuses or processes described below. It is possible that an apparatus or process described below is not an implementation of any claimed subject matter.

Furthermore, numerous specific details are set forth in order to provide a thorough understanding of the implementations described herein. However, it will be understood by those skilled in the relevant arts that the implementations described herein may be practiced without these specific details. In other instances, well-known methods, procedures and components have not been described in detail so as not to obscure the implementations described herein.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” may be construed as X only, Y only, Z only, or any combination of two or more items X, Y, and Z (e.g., XYZ, XY, YZ, ZZ, and the like). Similar logic may be applied for two or more items in any occurrence of “at least one . . . ” and “one or more . . . ” language.

The systems, devices and methods described herein provide, in accordance with different embodiments, different scalable modular secure network systems, architectures and secure network modules therefor. As will be detailed further below, a set of secure network modules, as described herein, can be assembled to provide a customizable and scalable secure network architecture while reducing an overall hardware footprint and/or increasing an overall security of the assembled network services. For example, while standard secure network architectures generally involve the stacking of multiple rack-unit appliances stacked atop one another in a standard server rack and interconnected via standard networking cables, the solutions provided herein allow for a more compact disposition, optionally using standard server racks and related mounting equipment, of secure server modules that, in combination, can provide as secure and compact network architecture.

For example, in accordance with some embodiments, one or more secure network modules can be vertically disposed side-by-side within a server-rack mounted cradle, or the like, whereby the side-by-side secure network modules or blades can each optionally interface with an external network or component via standard networking cables, while securely interfacing with one another via an internal backend cradle connector arrangement. Accordingly, multiple vertically disposed secure network modules or blades can be scalably assembled into a secure network architecture, while minimizing a physical footprint thereof (e.g., 2, 3 or more standard rack unit (RU) spaces encompassed by a set of 6, 8, 10, 12 or more vertically oriented blade modules). In other embodiments, a set of adjacently disposed, horizontally oriented network blade modules may otherwise be assembled in a secure network architecture, for example, to fill a single rack unit while still providing the modularity and scalability of the larger vertically oriented embodiments. Furthermore, respective blade modules may be interchangeably used in a vertically oriented or horizontally oriented configuration depending on the network cradle being used for a particular purpose. A modular design as provided by the embodiments described herein further promote greater system interchangeability, upgrade, scalability, service, to name a few examples, as will become readily apparent to the skilled artisan upon reading of the following detailed description.

Furthermore, the set of network modules, residing in a single cradle chassis, connected via the backend cradle network, have capacity to self-organize and operate as a single digital entity. The various network modules may be operable to execute a common digital task, while each module is responsible for executing an individual component of the common digital task. Existing network modules will detect a new network module and leverage its capabilities when working cohesively to achieve a common digital task

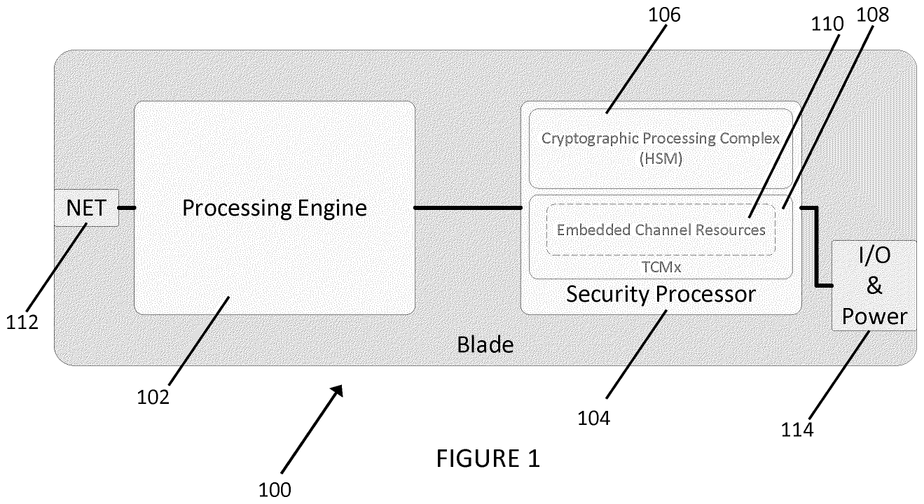

With reference to FIG. 1, and in accordance with one embodiment, a secure network module, generally referred to using the numeral 100, will now be described. In the illustrated embodiment, the module 100 generally comprises a processing engine 102 which may be operable to execute one or more digital processes related or in service to the network architecture in question, and a security processor 104 operable to execute one or more related network security processes, as will be described in greater detail below. For example, the processing engine 102 may include, but is not limited to, a processor such as a 4-core or 16-core Intel processor operating Linux or such operating system. Meanwhile, the security processor 104 may include, in accordance with one embodiment, and as will be further described below, a cryptographic processing complex 106, such as that provided by a hardware security module (HSM) or the like, and a hardwired interconnection matrix 108 encompassing, for example, a set of embedded hardwired channel resources 110 or the like. The illustrated module 100 further comprises an external network interface/connector 112 operatively disposed so to interface with a network interface of the processing engine 102, for example, and a back-end power and input/output interface/connector 114 operatively disposed so to interface with an internal network, such as a cradle network, as will be further described below.

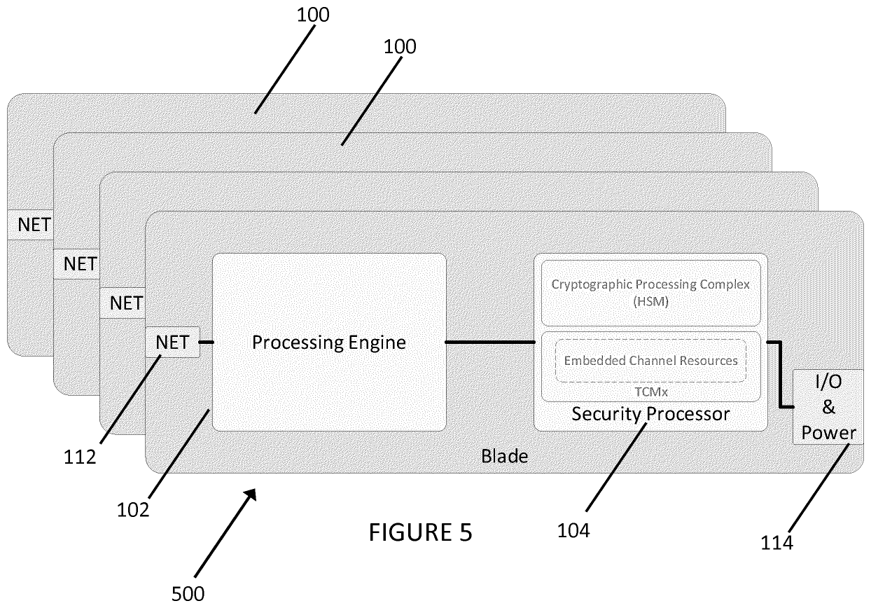

As noted above, a secure network architecture may be assembled using a number of secure network modules, such as module 100 of FIG. 1, to provide suite of network-related services and functions as provided by the processing engine 102, while leveraging the cryptographic functions of the integrated security processor 104 of each module. FIG. 5 provides an example of a stacked architecture 500 comprising a set of modules 100, all or some of which may be operatively interfaced with an external network or component (including unsecured module interconnections) via their integrated network interface 112, while all or some may be further securely interconnected via their respective back-end (cradle) interface 114.

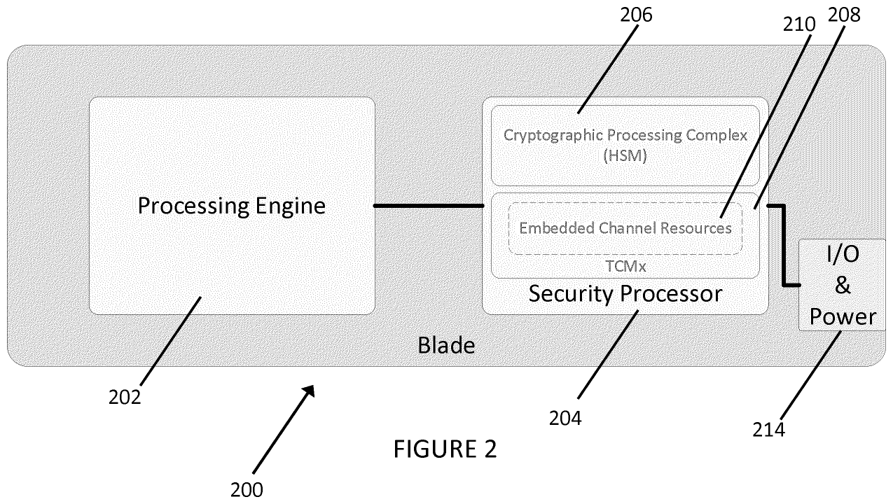

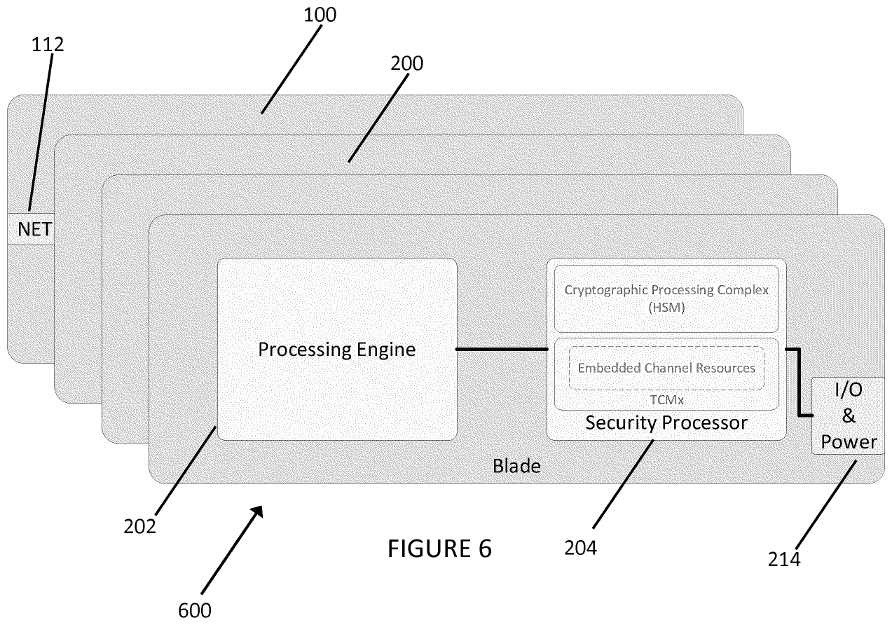

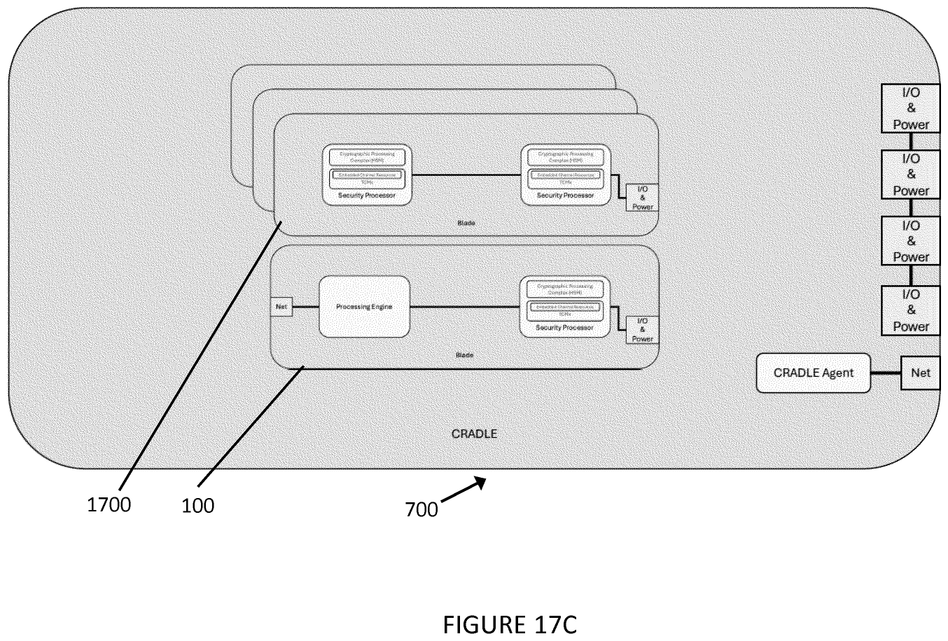

In some assemblies, however, a given network module may advantageously operate at a higher security level without direct external network interface. For example, with added reference to FIG. 2, a similar secure network module 200 may again comprise a processing engine 202 and security processor 204, the latter again encompassing a cryptographic processing complex 206 and interconnection matrix 208 embedding one or more hardware channel resources 210, but in this embodiment, (actively) comprising only a back-end power and input/output cradle interface 214. That is, the module 200 may be manufactured to exclude an external network port altogether, or again, be internally hardwired or configured to remove or avoid any operative link or interface to an included network port (e.g., where each module is manufactured in bulk to identically include a hardware network port, but where some modules are specifically internally designed or customized to render such hardware network port inoperable). FIG. 6 provides an example of a stacked architecture 600 comprising a first network-interfacing module 100, followed by a set of network-shielded modules 200. For example, an external connection could be activated through the network interface 112 of the first module 100, for instance to relay a request for secure network processing via an external communication network. In this instance the processing engine of the first module 100 could execute standard network server functions in managing inbound and outbound network communications. Meanwhile, the security process of the first module 100 could execute one or more cryptographic processes to securely channel inbound and outbound communications through the first module 100, while interfacing via the back-end connector to one or more downstream network-shielded modules 200, each one of which itself securely interfacing with the internal (cradle) network via its integrated security processor 204 to deliver secured network-related resources or services via its integrated and network-shielded processing engine 202. In such embodiments, a processing engine 202 of a network-shielded module may operate as a confidential compute engine in which the processor and memory thereof operate in an enhanced network security environment. Such confidential resources may provide direct services for a particular application, or again act as a centralized network resources for other modules. For example, a given module may be configured to include a high precision timing device, such as an atomic clock, and securely provide a trusted time resource for all other modules in its cluster and/or adjacent clusters (e.g. see FIG. 18). Accordingly, this network-shielded module may be in service to other modules who take advantage of the enhanced security environment of this network-shielded module. As will be appreciated by the skilled artisan, alternative embodiments may include a stacked architecture consisting exclusively of a set of network-shielded modules 200, for instance, of dedicated local implementation, or again provided within the context of a multiple-cradle implementation deploying secure cross-cradle communications, for example.

In these examples, the external network shielded compute blades can operate as Confidential Compute Blades, even in the absence of a security processor. For example, a simplified confidential compute blade can be used to guarantee the confidential execution of software loads. As the network ports on the front of the module are removed/disabled, all communications must take place through the backplane connector from another blade that contains a security processor and they would communicate securely through quantum safe inter-HSM communications. The Single Board Computer (SBC) in this configuration would not have any external network interfaces available but could expose an internal network interface through the backplane connector for management purposes only, for example.

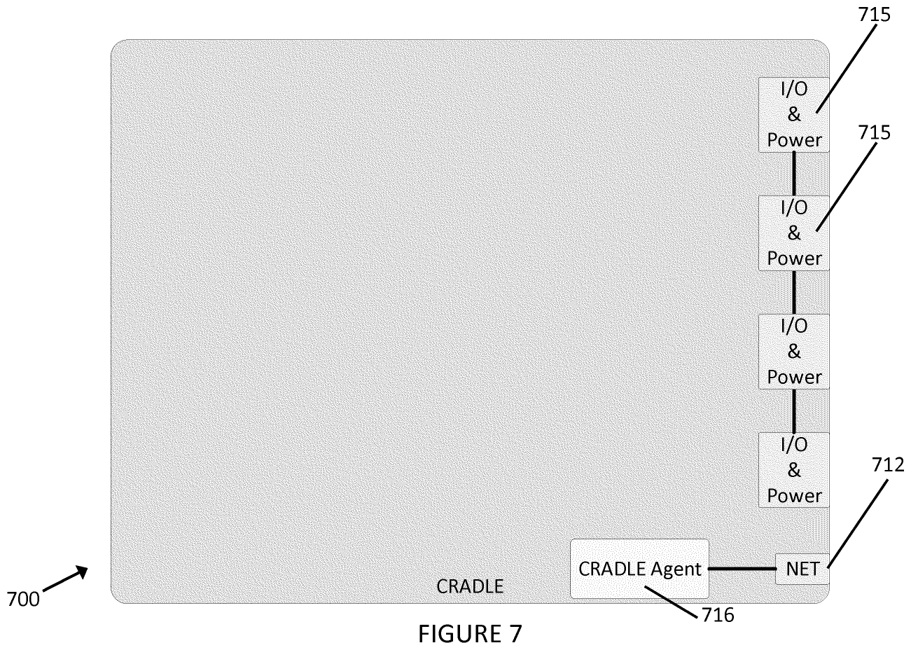

With reference now to FIG. 7, and in accordance with one embodiment, an example of a cradle 700, will now be described. In the illustrated embodiment, the cradle 700 generally comprises a set of module-interfacing hardwired input/output and power interfaces 715 each physically disposed to receive operative engagement with respective secure network modules, such as modules 100 and/or 200 of FIGS. 1 and 2, respectively. As noted above, these cradle interfaces 715 allow for the secure interconnection of mounted modules with one another. The cradle 700 also illustratively comprises operatively mounted therein a cradle agent 716, in this embodiment, providing its own external hardwired network interface 712. In some embodiments, this interface may provide limited external connectivity through the cradle interfaces 715 to the mounted modules, so to permit, for example, operative management access to the cradle 700 and mounted modules thereof. For example, the external network-interfacing cradle agent 716 may be hardwired within the cradle 700 to provide a communicative interface to a corresponding hardwired management or administrative port available at each module cradle interface 715. For instance, the cradle agent 716 may have limited communicative and operative access to each module via its dedicated hardware-isolated port, whereby operational management resources (cooling fans, power, operating temperature, network communicatively, anti-tamper sensors, etc.) can be accessed, reported on and/or managed, for example via the external cradle interface 712, without breaching any security protocols or processes implemented by and/or between mounted modules.

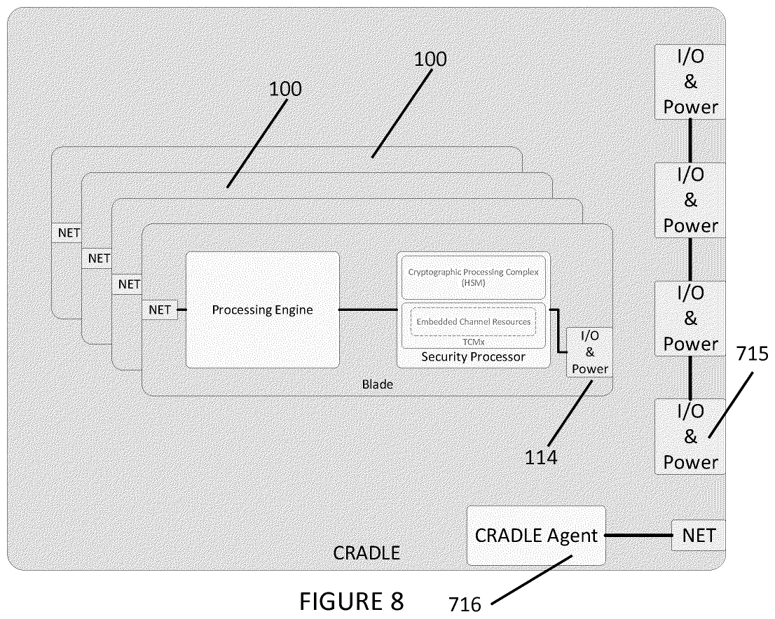

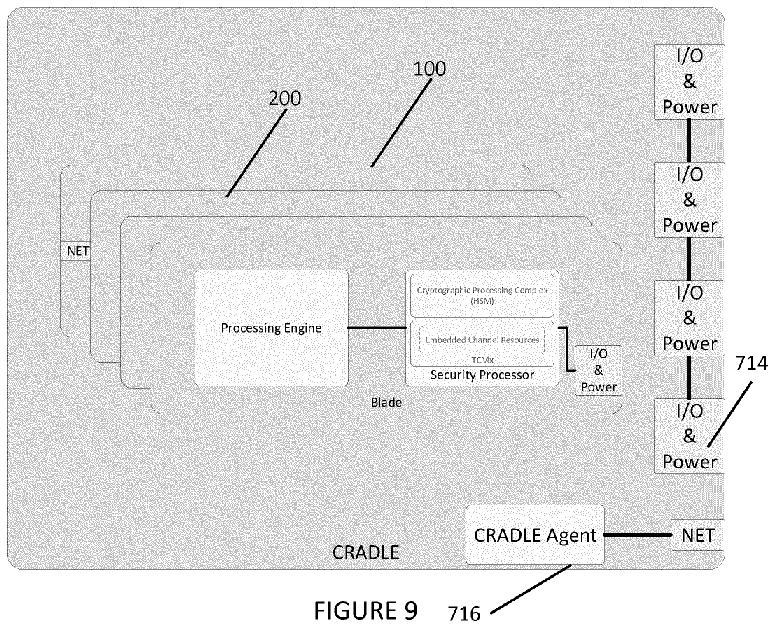

FIG. 8 illustrates one cradle-mounted architecture in which a set of external network-interfacing modules 100 are operatively mounted via respective cradle interfaces 114 to integrated cradle interfaces 715 to optionally securely interface with one another via dedicated hardwired intermodular port(s) and channel(s), and/or with the cradle agent 716 via a dedicated hardwired cradle port(s) and channel(s). Similarly, FIG. 9 illustrates another cradle-mounted architecture in which a first external network-interfacing module 100 is operatively mounted via corresponding cradle interface to an integrated cradle interface 715 to securely interface with one or more downstream network-shielded modules 200 via dedicated hardwired intermodular port(s) and channel(s), and/or with the cradle agent 716 via a dedicated hardwired cradle port(s) and channel(s). For example, in some embodiments, the (proprietary) back-end module cradle connector may include a plurality of port pins configurable to interface over respective hardware cradle network channels with respective downstream and/or upstream modules. Indeed, the cradle network and related connectors and hardware-defined communication channels can be distributed such that critical communication paths (e.g. secure intermodular communications) are restricted to a certain subset of hardware channels, whereas other less critical channels (maintenance, monitoring, operational status, environmental sensors, etc.) are relayed and restricted to other hardware channels, for example, such as those interfacing with the cradle agent or the like.

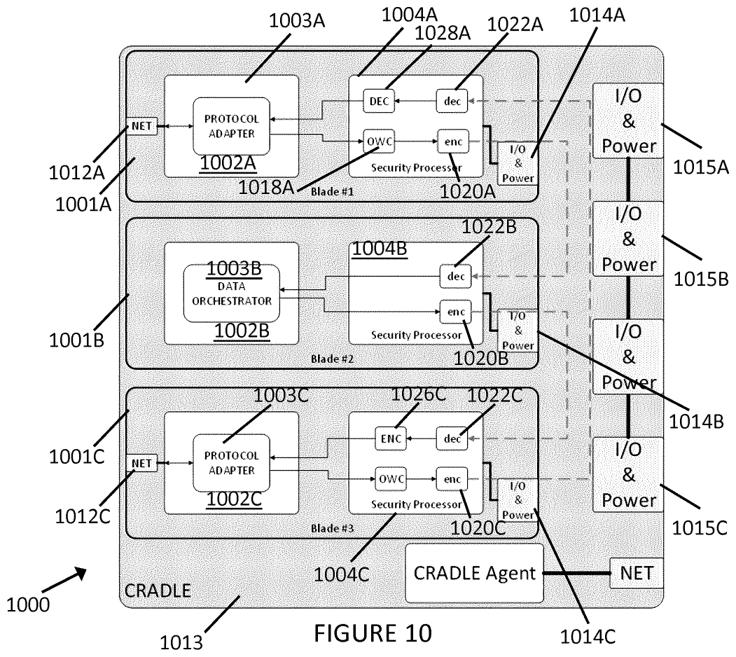

With reference to FIG. 10, and in accordance with one embodiment, a high-level schematic representation of a Cross-Domain Solution (CDS) 1000 employing a plurality of secure network modules 1001, as described herein, will now be described. In this example, a multiplicity of domains can be operationally connected to a corresponding one of a plurality of secure network modules, whereby cross-domain enforcement points can be securely implemented via, for example, the back-end cradle connector network forming a secure cross-domain network in this embodiment. This type of cross-domain enforcement and service deployment was illustratively described in Applicant's U.S. Pat. No. 11,310,198 issued Apr. 19, 2022, the entire disclosure of which is hereby incorporated herein by reference. In that illustrated example, two or more Security Processing Appliances (SPAs) were deployed to interface with one another via an “Elevator network” that acts as an interconnect point that allows the SPAs, each dedicated in that example to its own specific corresponding security domain, to transfer encrypted data that can only be delivered to a specific destination security domain. In other words, the elevator network may act as an “elevator shaft” where domain-specific data, which is correspondingly encrypted for domain specificity, enters on a specific floor (i.e., security domain) and can either be elevated or lowered to another specific destination floor and only successfully decrypted (processed) thereon based on said domain specific encryption.

In FIG. 10, three (3) secure network modules 1001A, 1001B and 1001C are configured and operatively mounted in a same cradle 1013 via their respective back-end I/O port/interfaces 1014A, 1014B and 1014C, and respective cradle ports 1015A, 1015B and 1015C, to securely channel communications between two distinct network security domains, each illustratively communicatively accessed via respective external network interfaces 1012A and 1012C. Notably, in this embodiment, the assembly 1000 comprises two secure network modules 1001A and 1001C each having a respective external network interface, and one secure network module 1001B externally inaccessible (in hardware, i.e. devoid of a physical external network port/interface, or in firmware/software whereby an included physical external network port/interface is inoperable and/or communicatively inaccessible).

In the illustrated embodiment, a secure “elevator network” is effectively dispatched via the cradle network deployed in hardware between the respective network modules through respective secure cradle interfaces.

In the first network module, a processing engine 1002A is configured to operate as a protocol adapter 1003A for interfacing with a communication protocol of the first (lower) network security domain on network interface 1012A. For example, the protocol adapter may be responsible to provide an appropriate protocol hand-off for the information inbound on network interface 1012A (e.g., lower security domain request). Once protocol adaptor 1003A has extracted a complete or partial unit of information deemed sufficient to be filtered and transferred to another domain, this extracted information is relayed in hardware to the integrated security processor 1004A that is configured via its embedded HSM (not explicitly shown) to securely relay the extracted information for cross-domain processing. For example, the security processor 1004A can be configured in hardware to implement a One-Way Channel (OWC) 1018A, enforced for example by an embedded trusted communication matrix using, for example, a data diode or similar, and inter-module encryption 1020A, before egress to the cradle elevator network to further downstream processing. As illustrated, inbound security domain information can be preliminarily processed and secured by the first secure network module 1001A and securely relayed between secure network modules via embedded encryption resources.

From the cradle elevator network, the encrypted information output from the first network module 1001A can be securely received via the back-end cradle network channel port to second network module 1001B, which first interfaces with this module's embedded security processor 1004B where the extracted and encrypted information can be decrypted by embedded cryptographic resources (inter-module decryption 1022B) for further processing. For instance, the second network module 1001B, which interfaces with other network modules only via the secure back-end cradle elevator network, and is devoid of external network interfacing, provides an exclusive secure information processing path to its embedded processing engine 1002B, in this embodiment, operating as a Data Orchestrator 1003B. For example, once a unit of information is received by Data Orchestrator 1003B, it is operable to determine the appropriate filter or set of filter function(s), for example, that may need be applied to that specific type of information. Data Orchestrator 1003B proceeds to orchestrate the appropriate filtering steps, as will be readily understood by the skilled artisan. The Data Orchestrator may implement one or more filtering function based on a wide range of criteria. For example and without limitation, a filtering function may be applied based on the content of the data being transferred; based on the meta-data of the data being transferred (e.g. headers or tags with information about the data); based on a time window (e.g. from an initial time and data to an end time and date); based on metering of data transactions (e.g. apply filter only for the first 1000 units of information received, for example). Accordingly, Data Orchestrator, in some embodiments, may take the form of a cross-domain data validation engine, for example, operable to validate and thus approve (refuse) or seek approval for the data transaction to proceed to the next domain.

Upon having completed the necessary application of filters to the specific unit of information, the Data Orchestrator relays the filtered output back through the embedded security processor 1004B and its integrated inter-module encryption engine 1020B, for example, via a distinct integrated hardware port of an embedded HSM, for further inter-module encryption and dispatch via secure cradle network, for further processing via subsequent network module 1001C.

Much as above between the first two modules 1001A and 1001B, the filtered information output from the data orchestrator 1003B can be securely relayed, encrypted, to the third network module 1001C via the secure cradle network, where it is first received through the security processor 1004C and the inter-module decryption resources 1022C thereof. The security processor 1004C can then proceed to encrypt the filtered information (domain-level encryption engine 1026C) for processing by the protocol adapter 1003C executed by the third module's processing engine 1002C for dispatch on second (higher) security domain.

In the reverse order, communication inbound from the second security domain (e.g., response inbound from a higher security domain) via module 1001C is processed by the embedded protocol adapter 1003C, relayed by an embedded One-Way Channel 1018C and encryption resources 1020C of the integrated security processor 1004C, to interface with the first network module 1001A through the cradle network. There, the extracted and encrypted information (response) is decrypted by embedded inter-module decryption resources 1022A, and the embedded information (response) from the second (higher) security domain further decrypted via embedded domain-specific decryption resource 1028A before being handed off to the first domain protocol adapter 1003A for communication on the first network security domain level.

As illustrated, communications can be securely related between network security domains while executing inter-domain processing, for example, by executing secure inter-module encryption/decryption for all communication relayed via the back-end cradle network. Furthermore, using a stack of network security modules as described herein, the cross-domain solution can be implemented with minimal customization, each module processing engine and security processor being readily adaptable for its intended purpose(s) with integrated cross-domain and inter-module cryptographic resources available and operable in respective secure hardware integrated environments.

The skilled artisan will understand that, in some embodiments, a different number of independent secure network modules may be used to expand or diversify the cross-domain solution illustrated in FIG. 10, or alternatives thereto. Likewise, other solutions may be assembled from a number of secure network modules, whereby inter-module communications may be securely relayed via the cradle network as the security processor of each module provides an internal integrated encryption/decryption resource to secure such communications. These encrypted inter-module communications via the hardware-integrated cradle network and dedicated module-specific cradle port channel connectors, can allow for the assembly of diverse secure network solutions.

Indeed, different network blade modules may be provided and/or combined to assemble a particular network architecture and/or implement a particular assembled modular network solution.

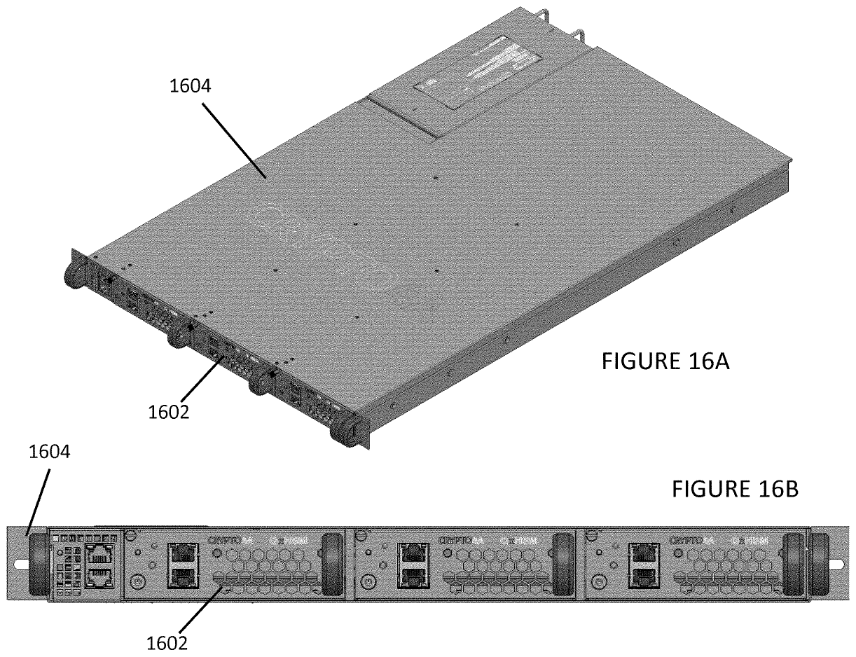

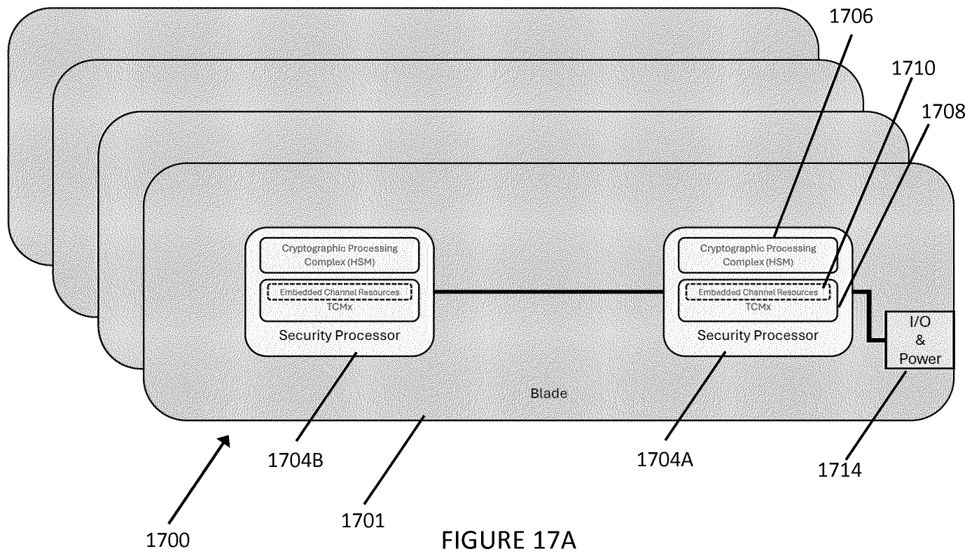

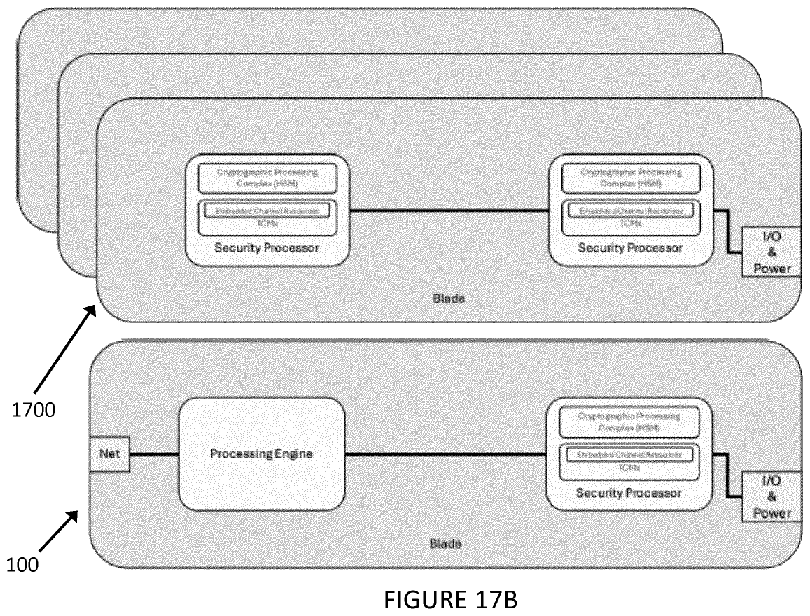

For example, and with reference FIG. 17A, a schematic diagram is provided of a scalable assembly of secure network modules 1700, comprising in this example, a dual quantum assured security blade module 1701 that integrates a pair of security processors 1704A and 1704B, each comprising a cryptographic processing complex 106, such as that provided by a hardware security module (HSM) or the like, and a hardwired interconnection matrix 1708 encompassing, for example, a set of embedded hardwired channel resources 1710 or the like. The blade module 1701 further comprises a back-end power and input/output interface/connector 1714 operatively disposed so to interface with an internal network, such as a cradle network, but in this embodiment, is devoid of a external network interface/connector, thereby relegating all module input/output communications to the cradle network connector.

In the illustrated embodiment, the additional security processor can act as a co-processor to another cryptographic blade operating within the modular assembly, thus allowing for increased overall encryption performance. While the cryptographic accelerator blade is illustrated as having two security processors, it will be appreciated that other embodiments may include only a single security processor, or again more than two in an more complex embodiment.

FIG. 17B provides a schematic diagram of a scalable assembly in which a dual quantum assured security blade module 1700, as show for example in FIG. 17A, is combined with a secure network module 100 operable to interface with an external network, as shown for example in FIG. 1, in accordance with one embodiment. In the illustrated assembly, the accelerator blade 1700 can act as an internal network-shielded co-processor to the secure network module's own internal security processor. As shown in FIG. 17C, the scalable assembly can be operatively mounted to a cradle 700, such as that illustrated in FIG. 7, whereby communications between the secure network module 100 and accelerator blade 1700 is isolated to the integrated cradle network.

With reference to FIG. 18, a schematic diagram is provided of a scalable assembly of secure network modules comprising, in this example, a time synchronization blade module 1800. Much as the secure network module 100 of FIG. 1, the time synchronization module comprises a processing engine 1802, a Security Processor 1804, an external network interface 1812, and a cradle network input/output interface 1814. In additional, the module 1800 further comprises a Chip Scale Atomic Clock (CSAC) 1822, a Global Positioning System (GPS) chip 1820, and an external GPS interface (antenna) 1815. In one example, the time synchronization module 1800 can provide precision time recordings to all or some of the other modules in the same chassis, while also applying precision time recording to external network devices in the data center, for example. For instance, the software load can contain additional applications that allow the blade to provide precision to other blades in the chassis, in the HSM cluster, or to external network devices in the data center.

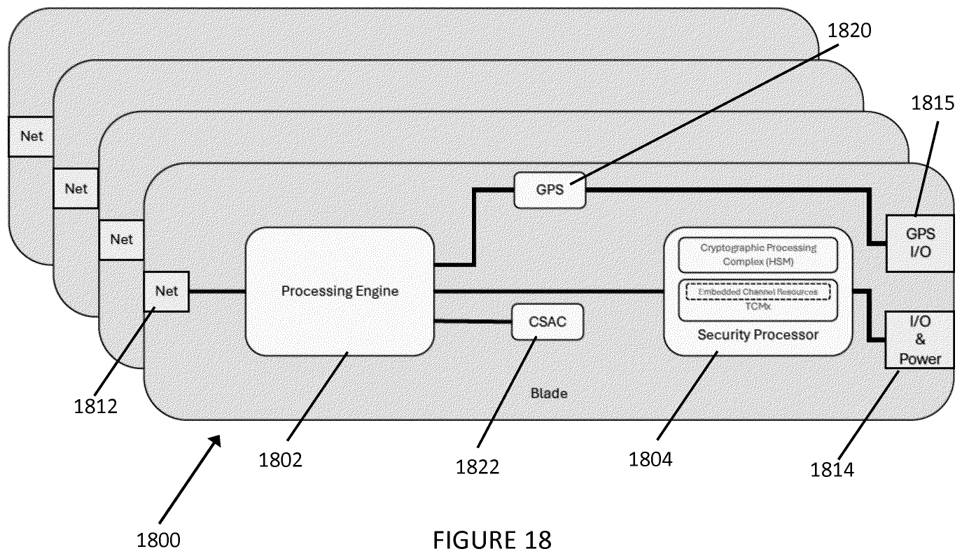

With reference to FIG. 19, a schematic diagram is provided of a scalable assembly of secure network modules comprising, in this example, a geolocation synchronization blade module 1900. Much as the secure network module 100 of FIG. 1, the geolocation synchronization module comprises a processing engine 1902, a Security Processor 1904, an external network interface 1912, and a cradle network input/output interface 1914. In additional, the module 1900 further comprises a GPS chip 1920, and an external GPS interface (antenna) 1915. In general, this module may be configured to securely record/track/report the exact location of itself and its associated neighboring modules/chassis. It may also be operable to restrict and/or enable location-dependent functionalities, for example, acting as a geo lock blade in some respects. Internal features may also be included to perform certain actions based on locations, such as alerts, zeroization, or to not allow certain functions, for example.

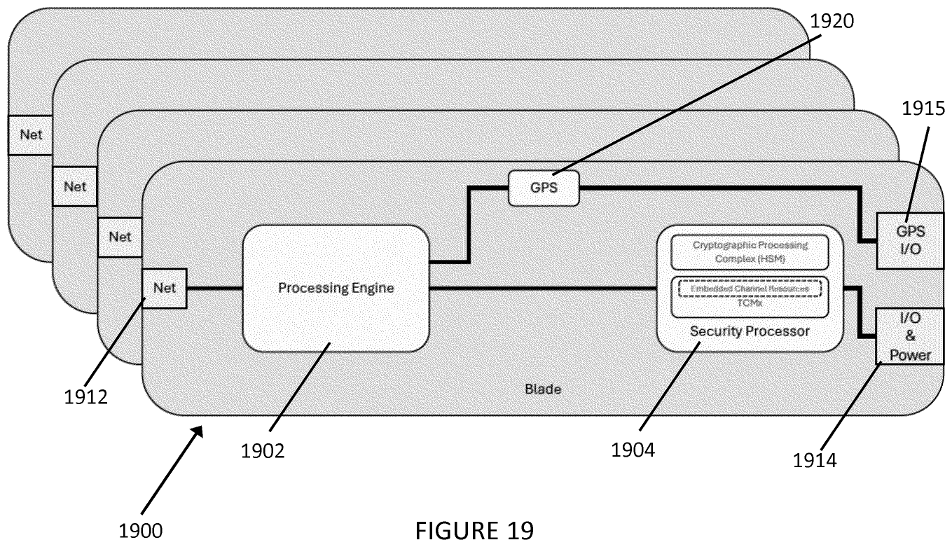

In FIG. 20, a schematic diagram of a scalable assembly of secure network modules is provided, comprising in this example, a network switch blade module 2000. In this example, the module 2000 comprises a processing engine 2002 operatively copulated between a cradle network coupler 2014 and a network switch processor 2040, itself operatively connected to an external network interface 2012 and a set of local area network (LAN) interfaces (connectors) 2013. Accordingly, the module can provide for multiple network connections to the assembly of network modules. This blade may, for example, include any number of LAN ports, such as 4 or 8, and/or include other network ports such as Gigabit Ethernet ports or Small Form Factor (SFP), enhanced SFP (SFP+) and/or quad SFP (QSFP) ports, for example.

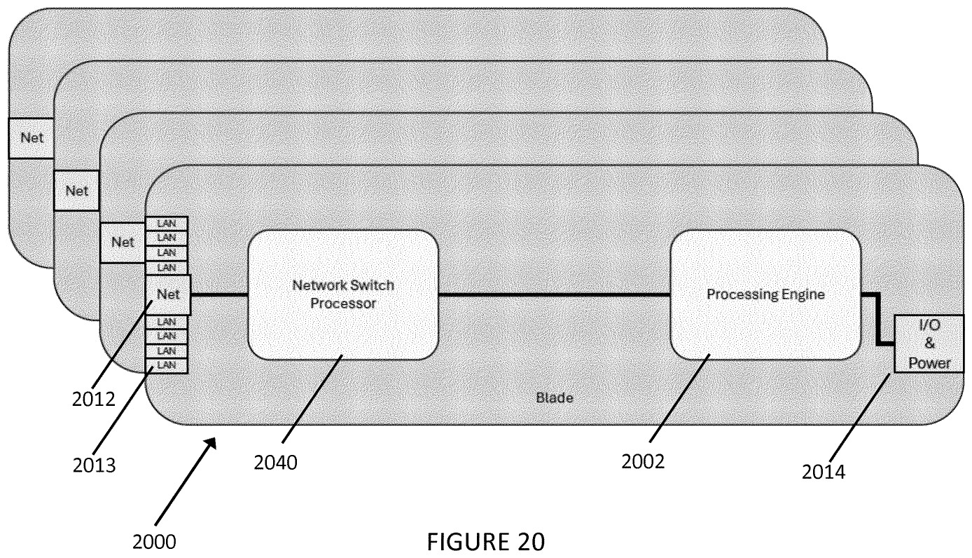

FIG. 21 is a schematic diagram of a scalable assembly of secure network modules, comprising in this example, a network blade module 2100 integrating a processing engine 2102 and a Peripheral Component Interconnect Express (PCIe) interface 2130, in accordance with one embodiment. In such embodiments, this may allow for the integration of a third-party PCI card, for example, in further customizing the network architecture, and providing access to functions of the PCI card locally and via the integrated processing engine 2102 and cradle network interface 2114. For example, a third-party HSM may be integrated in this matter. In some examples, a PCIe blade may require a larger footprint (e.g. double wide) to accommodate different PCIe cards that are larger, and include a serviceable lid to allow for card installation. Accordingly, it may further include connectors to integrate with anti-tamper sensor headers, for example, on existing PCIe based HSMs such as Luna HSM PCIe.

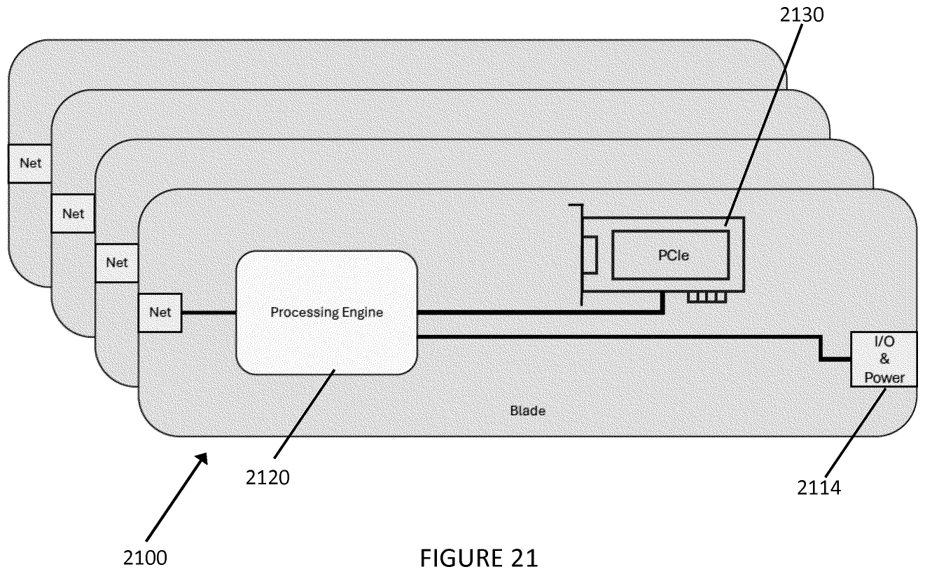

Similarly, FIG. 22 provides a schematic diagram of a scalable assembly of secure network modules, in this case, comprising dual PCIe interfaces 2230A (primary) and 2230B (secondary), interconnected by a PCIe bridge 2232 to cradle interface 2214, thereby allowing for the hardware integration and assembly implementation of two third party PCI cards, in accordance with one embodiment. In such embodiments, a dual PCIe blade may be configured to communicate only on the restricted plane (cradle network), and be paired with another blade module that contains a SBC such as a compute blade.

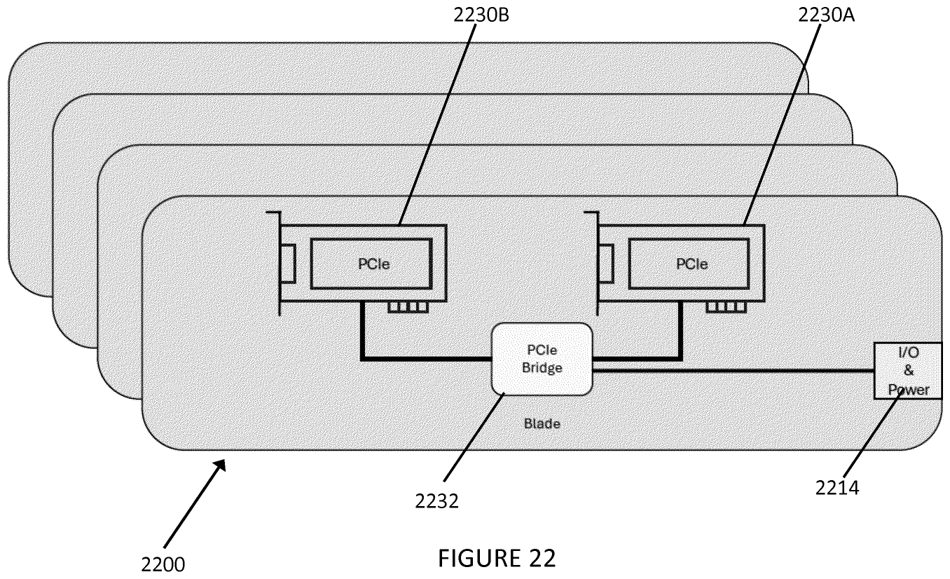

In FIG. 23, a schematic diagram is provided of a scalable assembly of secure network modules comprising, in this example, a dual compute blade module 2300 having two hardware integrated and segregated processing engines 2302A and 2302B, in accordance with one embodiment, each with an independent network interface 2312A and 2312B, respectively, and cradle interface 2314A and 2314B. In one example, a dual compute blade module, when implemented in conjunction with an adjacent blade security processor, can form a data safeguard by allowing data to only flow in one particular direction (e.g. inbound vs. outbound). Indeed, a dual compute blade may create, with an adjacent security blade, a data diode/data guard where the two front facing Ethernet ports are physically separated and the actual Data Diode functionality takes place in the neighboring blade containing the HSM. A variant of this blade could also be provided that is devoid of front facing Ethernet ports and that can be used in a confidential compute configuration.

As will be appreciated by the skilled artisan, different combinations of blade modules and module types may be contemplated to provide different network architectures and solutions. Further, a set of secure network modules with varying functionalities may be assembled to provide a customizable network architecture, with certain network module embodiments optionally allowing for additional user hardware connection ports, further allowing for additional customizable hardware.

In accordance with some embodiments, the chassis/cradle may extend further functionalities in the form of a smart or intelligent chassis. For example, some simplified chassis embodiments may have limited functionality, even in some embodiments relegating cooling functions to the blades rather than to provide them at the chassis level. However, enhanced or upgradable chassis are also contemplated that enhance the capabilities of the chassis.

For example, a smart chassis implementation may include a self-contained module that can be plugged in to a smart/intelligent capable chassis. When none of these modules are detected in a chassis, the chassis performs exactly like the existing standard/simple chassis. But when one or more of these modules are inserted, extra capabilities are now provided to the blade modules from the chassis. These modules will have a connector on the back that will interface with a receptor in a slot in the chassis. These modules can be added to a chassis by the customer just like blade modules.

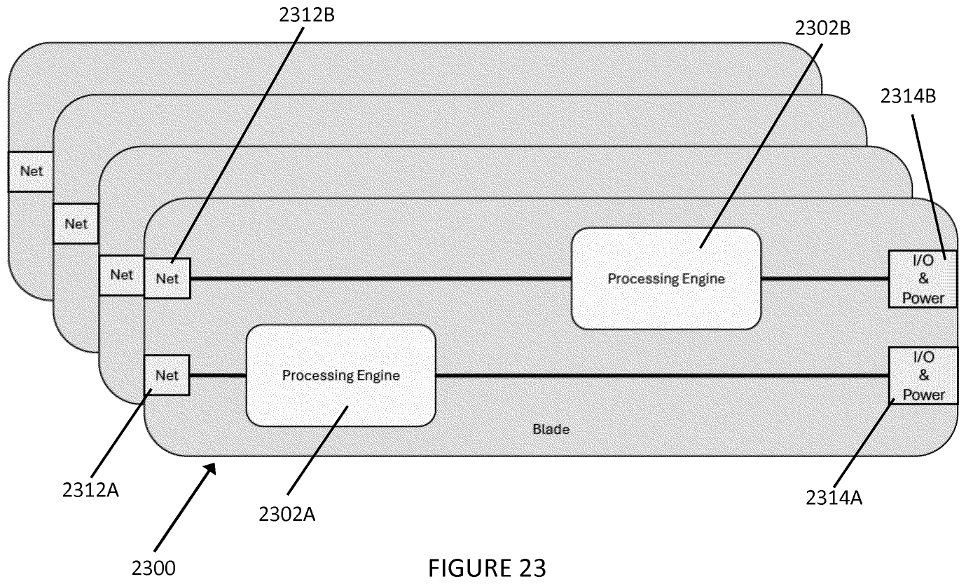

FIG. 24 provides an example of a further secure network module that may be operated as a smart chassis management module (SCMM), for example, comprising an integrated management engine 2450, an external network connector 2412 and cradle network interface 2414.

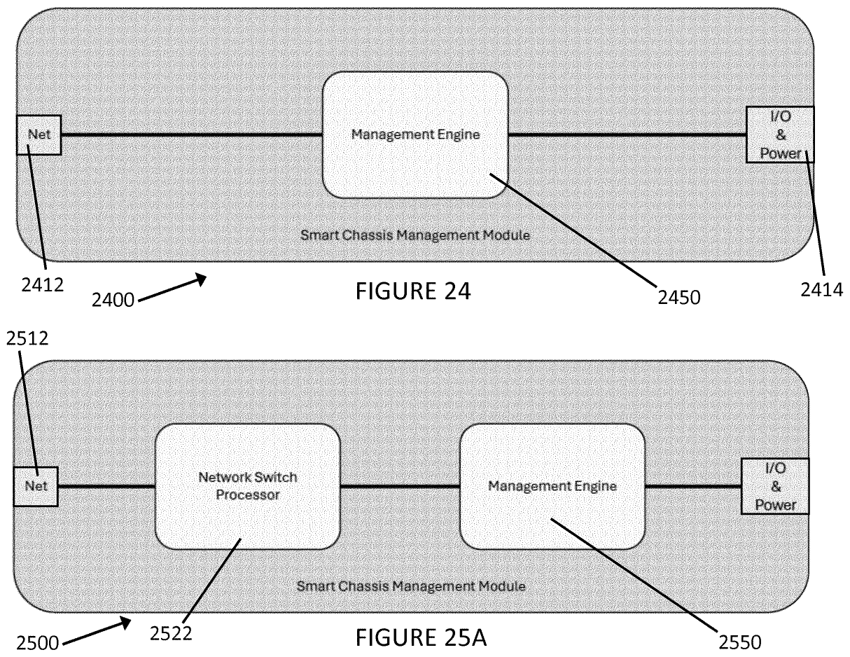

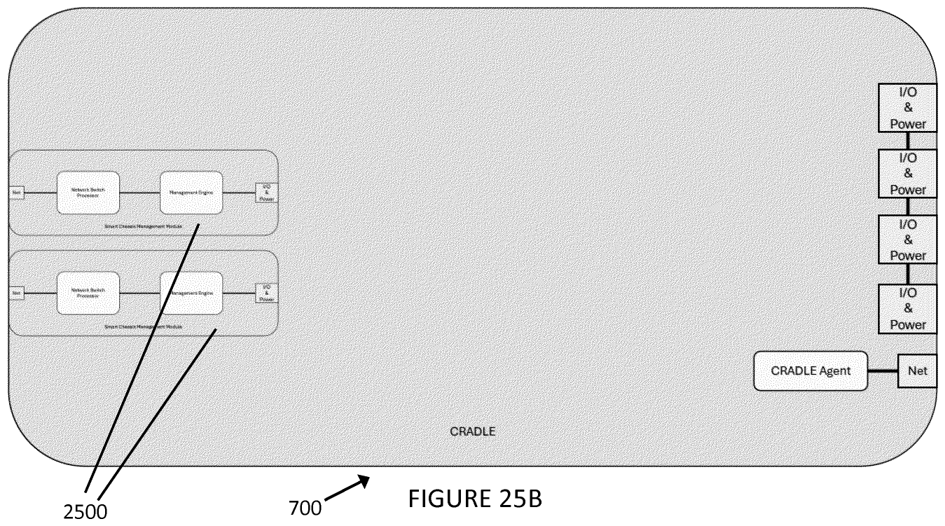

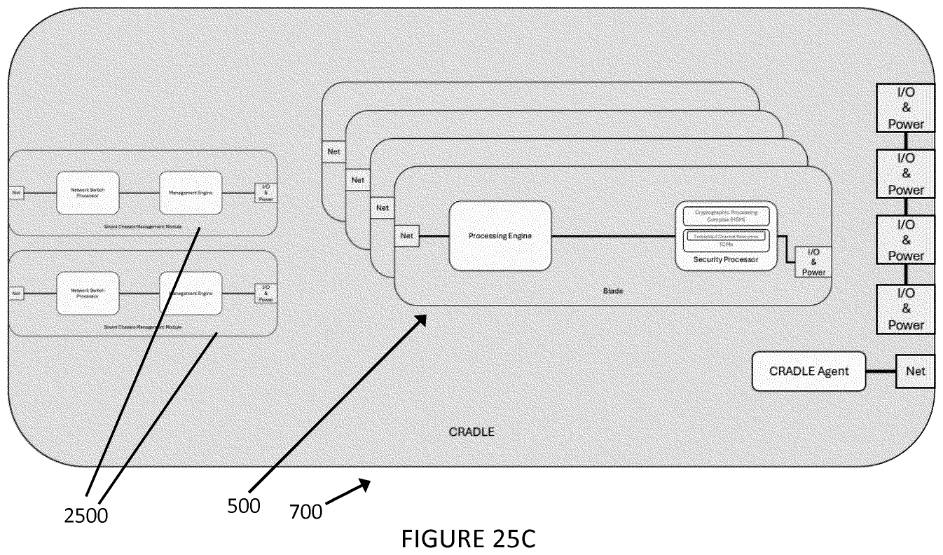

In a similar embodiment, as shown in FIG. 25A, a SCMM 2500 may further comprise a network switch processor 2522, along with its management engine 2550 and external (2512) and cradle (2514) network interfaces. Using this configuration, the SCMM 2500 can be used to interconnect the various integrated network modules, while allowing for the SCMM to connect to the Top Of Rack (TOR) network switch directly, removing the need for each network module to be connected individually. Furthermore, when two or more SCMM's are connected to a chassis, each network module gains Control and Data Plane separation capabilities, allowing various channels for communication between the various network modules, users and applications. Furthermore, additional chassis updates allow increased chassis functions. These modular chassis upgrades increase the chassis backplane communications and ability to communicate with various network modules and other network connected devices.

FIG. 25B illustrates the assembly of two SCMMs 2500 within a chassis 700, whereas FIG. 25C illustrates the further integration of an assembly of network modules 500, such as those illustrated in FIG. 5.

In the illustrated example, the SCMM contains a network switch that allows it to connect to all blade modules contained in the chassis through the backplane connector and a QSFP port at the front of the module to allow it to connect to the LAN. In this example, instead of having to connect each network security blade individually to a Top Of Rack (TOR) network switch, the chassis itself gets connected to the TOR switch with either a single or two network cables reducing the number of TOR switch ports that need to be consumed for the security blades. If two of the SCMMs are installed in a chassis then the Plane Separation feature is enabled allowing each blade module to have Control and Data Plane separation much like if they had individual Ethernet cables plugged into the two existing Ethernet ports.

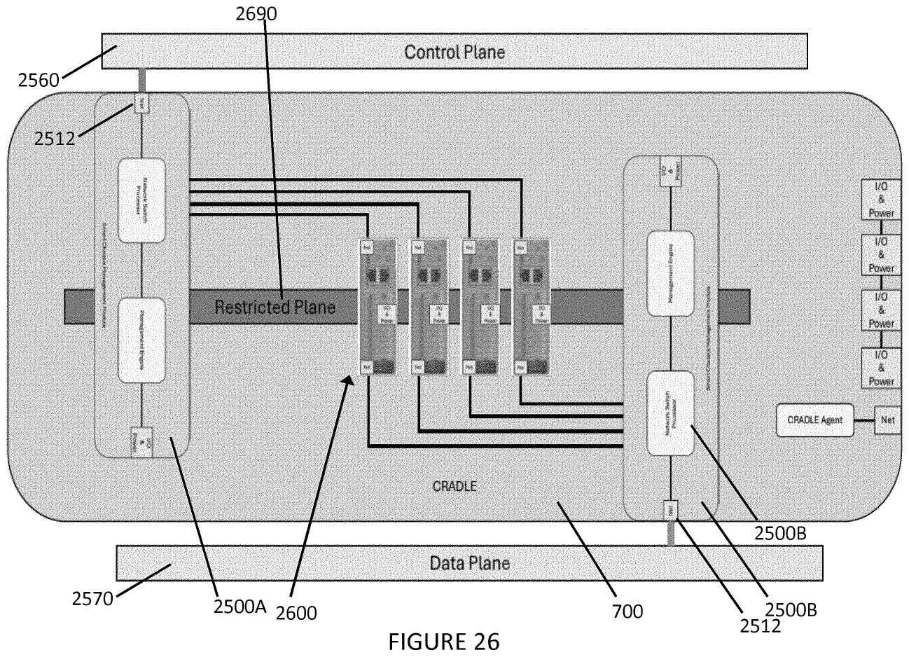

FIG. 26 provides a more detailed illustration of the above-noted integration of two SCMMs with a set of secure network modules. For example, this option may be deployed in cloud scale data centers connecting to the latest fiber optic network infrastructure while implementing full Control and Data plane separation. In the illustrated embodiment, two SCMMs (2500A and 2500B), such as those shown in FIG. 25A, interface with a control plane 2560 and data plane 2570, respectively, via respective external network interfaces thereof. Using their respectively integrated network switch processors, and integrated cradle network, data can be securely communicated in the restricted plane 2690 amongst the assembly of integrated network modules 2600, to achieve the intended functionality of the assembled network architecture.

For example, in one embodiment, the proposed assembly allows for maintained separation between user and management function in a deployed network architecture. For example, an network architecture may be deployed to define three major planes: a Control Plane (including a lights out interface), a Data Plane, and a Restricted Plane (e.g. defined by backplane connectors, or cradle network). In operation, the Control Plane on a hardware security module (HSM) will be connected on the IT management network and the Data Plane will live on a separate network where the Applications that need to consume HSM services reside and the users who consume those application services. Finally, the Restricted Plane exists in each physical chassis for communications between blade modules and the chassis itself. It is not exposed directly on either the Control or Data Plane but it is managed and configured through the Control Plane.

While the above describes certain illustrative embodiments, other embodiments may also be considered within the present context. For example, in one embodiment, a particular network module may be programmed to securely record and store the activities of the adjacent network modules. These blades may be interchangeable with other network blades and be removed temporarily or permanently for audit or inspection. For example, a data recorder blade of this nature may have for purpose of recording logs from other blades in the system and securely store them for later inspection by an auditor. This blade may have increased storage capacity, for example, but otherwise maintain similar hardware attributes as other standard network security blades integrating a security processor (HSM) or the like. For example, this blade could log HSM events such as, but not limited to, key generation, key usage, user events, and network configuration changes. This blade could be pulled from a chassis and replaced with another Security Audit Blade and it could be taken away for analysis or archiving, for example. Furthermore, in a self-organizing embodiment, an Audit Blade that inserted into a smart enabled chassis can be automatically recognized and identified, and other data security blades, may be configured to automatically send required audit logs to this Audit Blade.

In other examples, a simplified compute blade may be provided to host regular software applications that don't require cryptographic capabilities. In those circumstances, a security processor may not be required. Similarly, a storage blade may be provided to host applications that require increased physical storage capacity but that don't require cryptographic capabilities, for example, a large database.

Another example may include an incline encryption blade, configured to encrypt network traffic at line speed as it passes through from one network to another.

In yet another example, a payment blade may be provided that implements the cryptographic algorithms required by the Payment Card Industry (PCI) as well as comply to the PCI testing and standards such as PCI-HSM and PCI-DSS. In other embodiments, this functionality may be included in the same firmware and software load as a general purpose HSM blade, for example, rather than to require a usage-specific blade.

In yet another embodiment, a network module may be configured to operate as a single one-way data diode blade to ensure that data can only flow in one direction from a low side network to a high side network. Data guards and filters can also be implemented to run on the SBC, with data diode blades typically operated in pairs with one on the low side network and the other on the high side network.

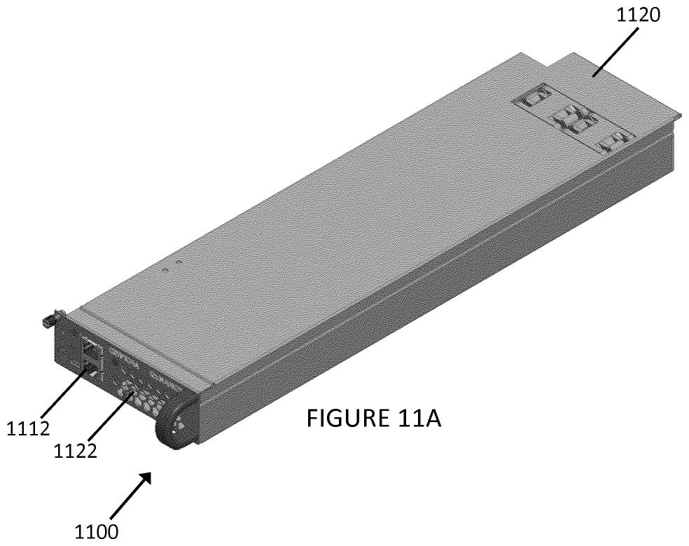

With reference now to FIGS. 11A to 11E, a secure network module, generally referred to using the numeral 1100, is illustrated to comprise a casing or housing 1120 dimensioned to be mounted and fit vertically within a standard sever rack, or the like, such that, a series of these modules may be so mounted side-by-side to take up three (3) vertical rack unit spaces. Externally, the secure network module presents two network (ethernet) connector interfaces 1112, for example, to provide redundant external network connectivity, front and rear ventilation 1122, and a proprietary back-end cradle network connector 1114. As noted above, the cradle network connector generally provides multi-channel or multi-port connectivity to adjacent modules and/or a cradle agent via an integrated hardwired cradle network.

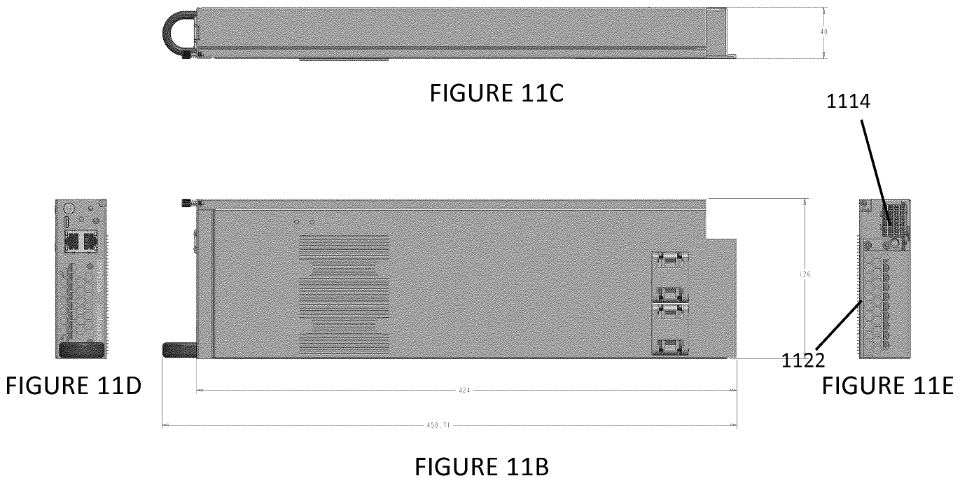

With added reference to FIG. 12, a perspective internal schematic view of the secure network module 1100 of FIG. 11A. is provided. In this embodiment, the module is shown to comprise an internal integrated processing engine 1102 and security processor 1104, the former operatively interfacing with the external network connector(s) 1112 and relaying external network traffic to and from the security processor 1104 via an integrated hardwired port interconnection, and the latter providing network security resources (e.g. encryption/decryption, inline security channel resources, etc.) for this external network traffic and/or to secure interfacing with other network modules via the secure cradle network port(s)/channel(s) 1114. In the illustrate embodiment, the processing engine is illustrated as a network attached host such as a Single Board Computer (SBC) or the like. In other embodiments, the processing engine may otherwise comprise a confidential compute engine or the like, for example executing confidential computations requiring an enhanced network security environment. For example, as noted above, traffic inbound from an external network connection 1112 may be fed into the security processor for cryptographic processing in a given module, however, in other configurations, secured communications may be relayed to a given module confidential compute engine via the secure cradle network connector and security processor of that module, thereby defining a cryptographically secure processing environment. By deactivating the external network connection, this cryptographically isolated processing engine can provide a secure hardware-isolated environment to process confidential information/data. As illustrated above with reference to the example of FIG. 10, a variety of computational configurations and/or applications may be applied to scale, level, escalate or diversify secure data processing using the external network connectivity and/or confidential compute resources interchangeable and customizable using a set of network modules as illustratively described herein. Other network module components, such as heatsinks, fans, digital storage media, hardware links or relays, power units, operating sensors/indicators, or the like may also be included, as will be readily apparent to the skilled artisan, without departing from the general scope and nature of the present disclosure.

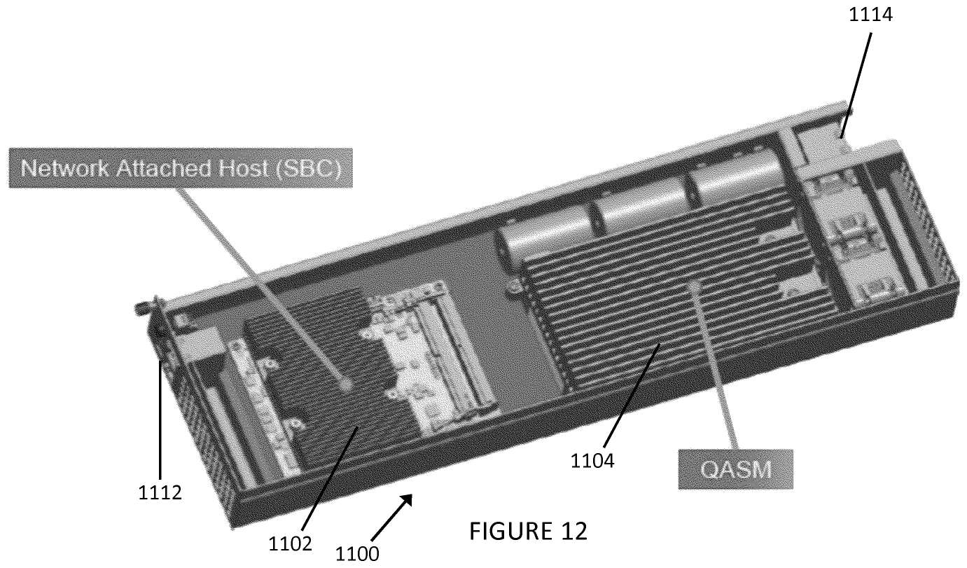

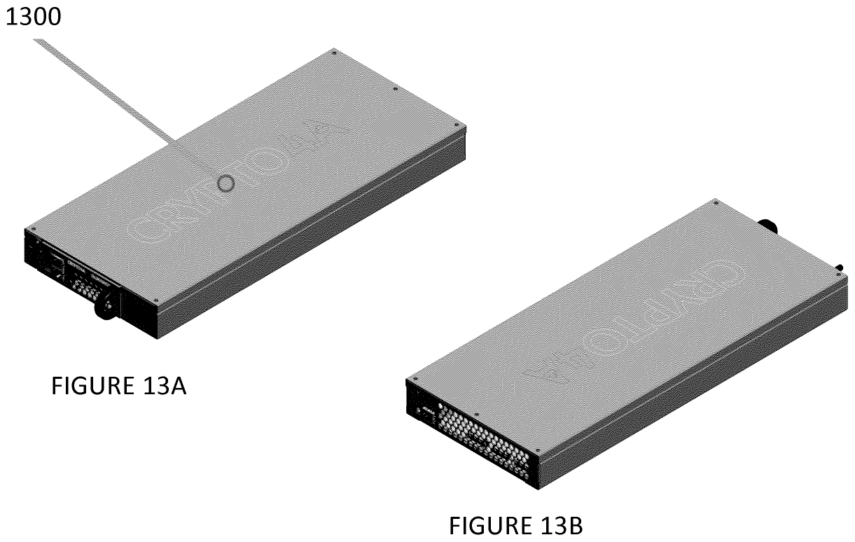

In FIGS. 13A to 13F, a single module desktop chassis 1300 having a single secure network module operatively received therein, is illustrated, in accordance with one embodiment. For example, a given network module may first be operated within one of these desktop configurations so to be configured for subsequent modular assembly. For example, each given module can be manufactured to include generic components in the form of an integrated processing engine and security processor, to be customized and adapted in-house, or for delivery, based on specific user requirements and a particular use case. Accordingly, the single module chassis may provide a suitable platform to power and allow a user to customize the module for specific use, or again, to allow for module upgrade, updates and/or servicing from time to time.

Indeed, currently available network appliances commonly require full replacement of internal processing cards or resources when facing an update, or otherwise, provide a small and cumbersome onboard screen to process updates and parameter adjustments. In comparison, a secure network module as described herein can be withdrawn from its cradle and updated via the desktop chassis, or again, access operating resources of the module via the external network connector.

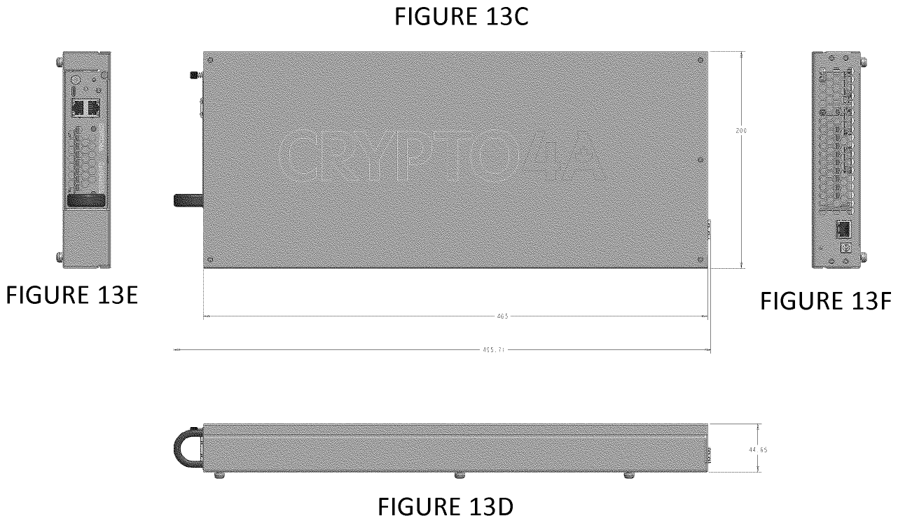

In FIG. 14, a 10-module chassis 1400 is illustrated having a set of 10 secure network modules 1402 operatively mounted therein and operatively interfacing with an integrated cradle thereof 1404 that can be operatively mounted or assembled to correspond with a 3-rack unit (3RU) space in a standard server rack, in accordance with one embodiment. This embodiment provides for linear scalability and high-density resource assembly.

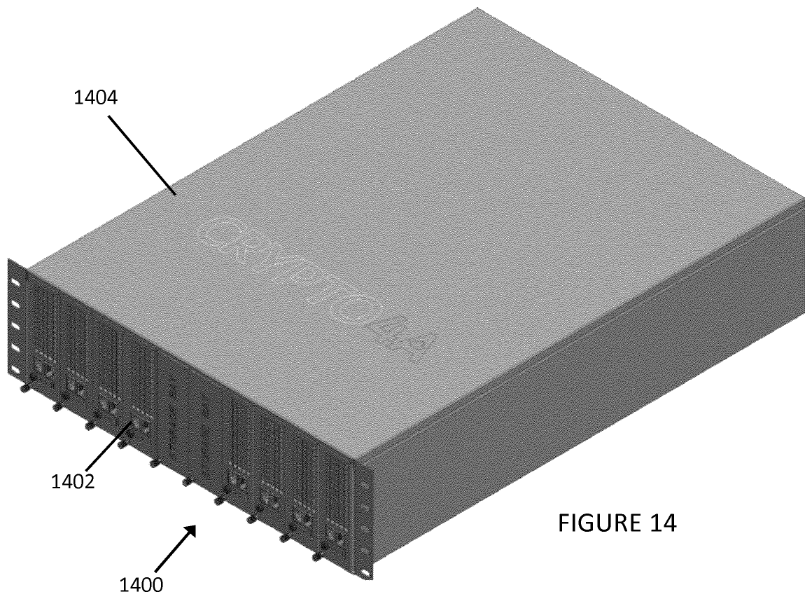

Similarly, in FIG. 15, a 12-module chassis 1500 is illustrated having a set of 12 secure network modules 1502 operatively mounted therein and operatively interfacing with an integrated cradle 1504 thereof that can be operatively mounted or assembled to correspond with a 3-OpenRack U (3OU) space in a larger server rack, in accordance with another embodiment. This embodiment provides for further linear scalability and high-density resource assembly.

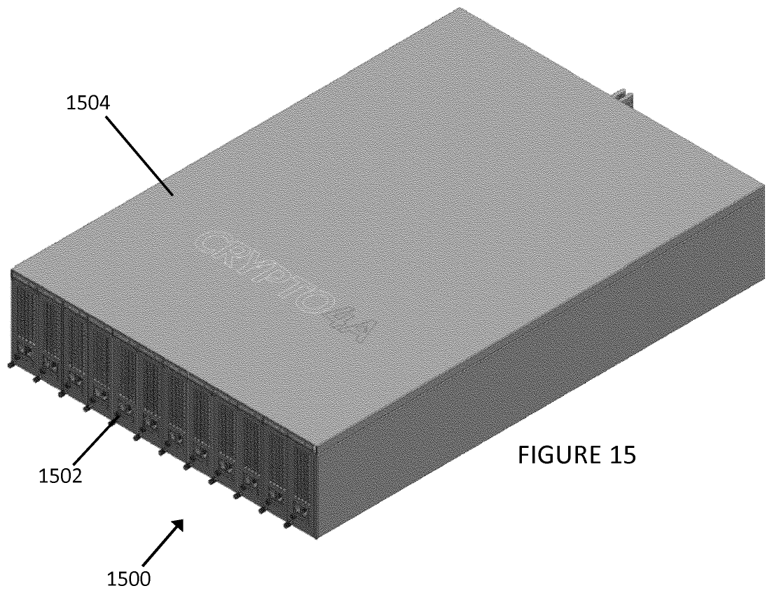

With reference to FIGS. 16A and 16B, and in accordance with another embodiment, a horizontally oriented 3-module chassis 1600 is illustrated having a set of 3 secure network modules 1602 operatively mounted therein and operatively interfacing with an integrated cradle 1604 thereof that can be operatively mounted or assembled to a corresponding 1RU space in a standard server rack. As noted above, the set of adjacently disposed, horizontally oriented network blade modules may be assembled in a secure network architecture, for example, to fill a single rack unit while still providing the modularity and scalability of the larger vertically oriented embodiments. Furthermore, respective blade modules may be interchangeably used in a vertically oriented or horizontally oriented configuration depending on the network cradle being used for a particular purpose. Furthermore, multiple cradled network dispositions may be combined using different configurations of vertically and/or horizontally disposed network module blades and their corresponding cradles. Namely, the same blades used in a vertically oriented 3RU cradle can be used, in some embodiments, in a correspondingly dimensioned 1RU horizontal cradle. In that respect, a set of modular network blades can be assembled according to a customized network architecture, whether in a horizontal or vertical disposition, while reducing an otherwise required hardware footprint and promoting greater intra-network architecture security, integrity and management, in some embodiments.

In a further example, a chassis may be extended to encompass a 4RU footprint, for example to accept 10 blade modules installed in a vertical orientation, while also accepting two SCMMs, as described above for example in respect of the embodiment shown in FIG. 26. For example, this option may be deployed in cloud scale data centers connecting to the latest fiber optic network infrastructure while implementing full Control and Data plane separation. Naturally, while a 4RU chassis is contemplated, embodiments are not so limited, which could be increased to accommodate a greater number of blade modules in the chassis and/or additional SCMM slots beyond 2 by increasing the rack units height, for example.

As illustrated and described above, the secure network modules can provide for enhanced functionality, scalability, and spatial efficiency, amongst other possible advantages. For example, in a basic configuration, a modular network architecture may include a basic cradle that is dimensioned to define a plurality of juxtaposed network module slots, each optionally comprising in some embodiments at a terminal end thereof, a cradle slot interface to an integrated cradle communication network. For example, a cradle slot interface may in some embodiments provide power to the mounted network module and/or further provide communicative access to a cradle network which may, in some embodiments, provide for secure intermodular communications and/or communicate with a cradle agent or the like for management and/or monitoring purposes. As will be appreciated by the skilled artisan, a cradle within the present context will be defined broadly to encompass different structural casing, mounting and/or engagement mechanisms allowing one or more modules to be secured thereto and/or therein. As illustratively described above, a casing may be itself mountable or otherwise securable to a network rack or cabinet, for example, for use in a standard server room, data center or the like. Accordingly, while a fully encasing and structurally integral cradle is illustrated in the herein described embodiments, other structural configurations including more or less structural complexity and/or integrity may be considered without departing from the general scope and nature of the present disclosure. For example, in a fully encased embodiment, including full cabinet arrangements, a cradle network may be more structurally integrated within the cradle for the automatic structural engagement of respective cradle network connectors to corresponding network module cradle connectors upon insert or mounting such network modules. However, a structurally simpler cradle may rather include a rack shelf or mounting bracket, for example, that can still provide cradle network interconnectivity and/or respective module powering resources.

In any of these embodiments, the cradle may allow for a plurality of network modules to be mounted juxtaposed within respective network module slots. For example, network modules may be dimensioned to mount in a vertical orientation and juxtaposed horizontally across to fill the rack space allotted therefor via the cradle. In some embodiments as noted above, this rack space may include a height of 2 or more standard rack units, such as 3 rack units as illustrated in the disclosed embodiments.

Furthermore, while embodiments are illustrated herein as ultimately assembling a modular network architecture, each module may, in some embodiments, provide a standalone network solution, while encompassing a smaller footprint than traditional security network appliances, for example. Indeed, rather than to occupy a whole rack unit for itself, as common with current network appliances, a secure network module as described herein may rather effectively occupy a third or quarter of this space by sharing rack space with other standalone or assembled network modules juxtaposed therewith in a same cradle. Accordingly, a network attached HSM, for example, can be deployed in this form factor, whereby the module's processing engine can be configured to operate as an SBC or other external network interfacing engine, while providing cryptographic services therethrough via the integrated security processor and embedded cryptographic resources; in other words, combined self-sufficient integrated server and HSM resources. In such embodiments, the standalone network blade-shaped module may dispense of the back-end cradle network connector otherwise illustrated in other embodiments described herein, and rather provide direct standalone network resources within this reduced footprint, without limiting operability of other blade-shaped modules operatively mounted juxtaposed thereto. Formfactor advantages may also benefit from a reduction in footprint by dispensing of other components common in standard server architectures, such as adapters and ports for Super Video Graphics Array (SVGA), High-Definition Multimedia Interface (HDMI), etc. Meanwhile, the self-sufficient formfactor of the module may allow for greater diversity and flexibility in system deployment. For example, each module may be configured as a self-contained unit to include a power source interface (e.g. via multipurpose cradle port connector), temperature management (e.g. ventilation fan(s), heatsink, etc.), network interfacing resources, etc.

Naturally, a plurality of such standalone network security modules can be deployed and used in parallel in such configuration, as can a mix of standalone and combined modular network resources. Meanwhile, other embodiments and implementations will couple this server-attached HSM capabilities in a first module with a second network-shielded module operating its onboard HSM as a cryptographic hardware gatekeeper to an onboard confidential compute engine securely operating in association therewith.

In more complex architectures, a series of secure network modules can be deployed and operated in concert to provide a suite of secure network services, as illustrative described above, with network modules working in parallel and/or series depending on their intended application. In such complex configurations, at least some of the modules may be preconfigured to automate some of the deployment and intermodular communication tasks required at system initialization, or again during service updates, maintenance, or replacements. For example, each module may be configured upon powerup to self-identify and/or self-authenticate with clustered modules, for example, via their respective security processors/HSMs, so to automatically establish a secure communication path therewith and therebetween, and optionally, proceed thereafter with self-configuration to effectively collaborate with or amongst other network modules. This self-initialization and authentication can thus facilitate system buildout, maintenance and upgrades, whereby a new or replacement module can be automatically integrated within an operating cluster to extend, scale, update or provide a replacement for (hot swap) an operating cluster. This facility is greatly enhanced by having each module, in some embodiments, interface with one another over the cradle network via their respective HSM-embedded security processors. Indeed, the modules may be automatically configured to initiate a secure handshake process between onboard HSMs using a post-quantum algorithm using injected cryptographic data (keys, certificates). For example, a first module may automatically take the role of master module, with subsequent modules securely interfacing with this master to authenticate and configure itself to interface within its cluster. Accordingly, as noted above, the modules may have the capacity to self-organize and operate as a single digital entity capable of customization and scale, whereby the assembly or swarm of blade modules may be operable to execute a common digital task or function, while each constituent module is responsible for executing an individual component of the overall task. Indeed, in some embodiments, existing modules may be configured to automatically detect a new network module and leverage its capabilities when working cohesively to achieve the common overall function.

As such, a swarm of blade modules may be defined as a collective or group of self-organizing blade modules that reside inside a single chassis/cradle and communicate with each other through the Restricted Plane (backplane connector). Externally a Swarm will behave and present itself as a single entity but internally it will be comprised of multiple blade modules working together to deliver a common objective.

As noted above, the systems and devices described herein also provide, in accordance with different embodiments, different examples in which a hardware security module (HSM) is operable to concurrently service multiple applications and/or functions while minimizing system security risks that may otherwise be introduced when interfacing with a traditional (external) HSM, e.g. via an intermediary HSM access appliance, application layer or HSM access software.

For instance, in some embodiments, the HSM of each security processor may comprise a plurality of hardware ports, each one configured or reconfigurable to receive input (e.g. public data, public key, etc.) thereon to execute a designated cryptographic process within the HSM in servicing a particular computational process, application or function. In general, received input data will be port-specific in that only input cryptographic data specific to the port on which it is received can be successfully processed. To do so, each hardware port will generally have defined in association therewith a corresponding hardware link or channel (e.g. static and/or reconfigurable hardware link, channel and/or switch) to a segregated hardware storage media that stores secured port-specific cryptographic data thereon exclusively retrievable for processing as a function of received input data specific to that hardware port. For example, distinct embedded storage resources may be provided with respective hardware data links to their corresponding port, as can distinct storage partitions and/or zones be defined within a same embedded memory storage resource and accessed via dedicated hardware logic or the like. Namely, distinct embedded storage spaces or resources may encompass a physically segregated, separated and/or defined hardware storage space on one or more hardware storage devices (i.e. memory board, chip, component, etc.) that is physically paired, allocated and/or associated with a given port-specific cryptographic process. Each storage space may be designated or adapted to store one or more cryptographic keys and/or like cryptographic data usable in invoking and/or executing a given port-specific process. Accordingly, in some embodiments, a dedicated memory space may define a secure key space for a given cryptographic process and/or encompass storage capacity for other types of cryptographic and/or other related data. An integrated cryptographic engine, executed by an embedded or hardware-linked processor, can then be invoked to internally process the retrieved secured cryptographic data, for instance in conjunction with the input data, to produce an intended computation result.

Accordingly, the entire process can be relegated to the hardware space without invoking a software or application layer and thus, without opening the HSM to tampering opportunities that may otherwise present themselves in conventional HSMs. Conversely, the HSM embodiments described herein allow for a full, and in some embodiments a single-chip (i.e. static or reconfigurable (e.g. FPGA)) hardware solution that can be used to concurrently service multiple applications and/or processes from within a same tamper-resistant environment. Accordingly, the solutions provided herein may allow for a significant increase in security protocol ratings while also significantly reducing, in some embodiments, the hardware footprint required to implement complex network security architectures.

For instance, in some examples the HSM provided as part of each module security processor may distinctly interface with different components or processes of the system of which it forms part to segregate in hardware such processes in thereby enhancing an overall security rating of the system. For example, the security processor of a given module may provide a hardware port dedicated to interfacing with the onboard processing engine, while another hardware port thereof is relegated to interfacing with the back-end cradle network via the integrated module cradle interface and port-specific channel provided in hardware thereby. Indeed, the security processor may invoke multiple hardware ports thereof to communicate with different cradle ports or channels, for example, to execute different port-specific communications with distinct secure network modules, for example. This may be illustrated with the example of FIG. 9, in which port-specific communications may be hardware isolated for each data communication path illustrated, thus isolated ingress and egress communications in and out of each module, and therebetween, in module-specific hardware communication channeling.

As the person of ordinary skill in the art will appreciate, while complex multi-module solutions may invoke and benefit significantly from the multi-port HSM solution described herein, other more simplified solutions may be implemented without such hardware-port-specific complexity while still benefiting from some of the other attributes and advantages of the herein-described solutions, in accordance with different embodiments.

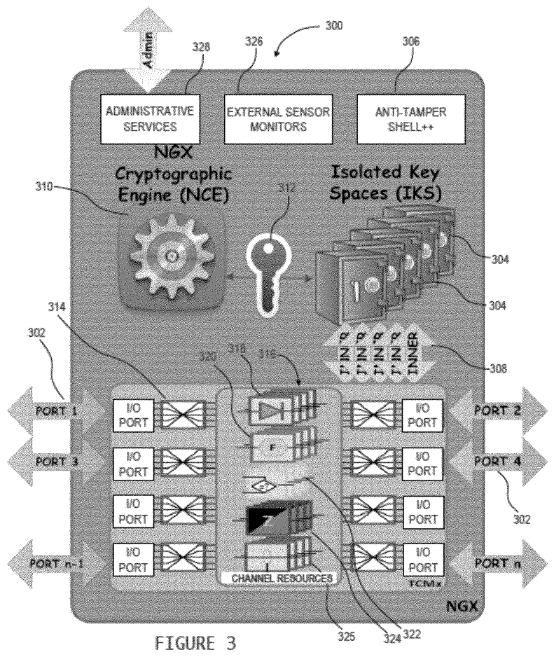

With reference to FIG. 3, and in accordance with one exemplary embodiment, a multi-port hardware security module (HSM), generally referred to using the numeral 300, will now be described. In the illustrated embodiment, the HSM 300 generally comprises a plurality of hardware ports 302 each operatively linked through hardware, e.g., direct hardware link or channel logic 308, to a corresponding port-specific hardware storage resource and key space 304 (e.g., distinct embedded memory storage device, hardware memory storage partition and/or zone). Each storage resource 304 can be configured to store secured port-specific cryptographic data (e.g., private encryption/decryption key 312) that is only retrievable upon input of corresponding input cryptographic data from a corresponding port. In other ports, secured data may be further secured by virtue of hardware port specificity, whereby input data received on an incorrect hardware port will fail to access corresponding secured data linked to this incorrect port, and also fail to access secured data linked with any other port.

Upon successful input of external data via an appropriate hardware port 302, corresponding secured data (e.g., key 312) can be internally retrieved and processed by an integrated engine (i.e., cryptographic engine 310) to deliver a desired outcome.

In this embodiment, the provision of hardware-linked HSM ports and segregated storage resources enhances overall system integrity and resilience to external tampering, while also providing the added benefit of HSM multiplicity within a common tamper-resistant solution. In fact, certain embodiments may efficiently multiply HSM resource allocations within a single chip implementation, e.g. with embedded memory(ies), processor(s) and hardware logic, while leveraging both the added security of distinctly segregated hardware-linked storage resource interfaces and the option to share internal hardware resources, such as a common integrated cryptographic engine 310 that may be invoked to concurrently or at least sequentially process secured data from multiple isolated key spaces 304. As will be described in further detail below, this integrated hardware implementation may further benefit the deployment of secure system architectures, as described above.

With continued reference to FIG. 3, in this embodiment, at least some of the hardware ports 202 can be linked through hardware to interface with distinct storage resources 304 and/or ports 302, and/or processes/data associated therewith, thereby defining a trusted communication (e.g. hardwired port interconnection) matrix 314 that can be leveraged in more complex system implementations to benefit from the secured co-location of distinct resources on a same hardware implementation (e.g. same hardware chip) without exposing the HSM 300 to external or software-related tampering risks. In other words, port-specificity can be maintained to govern access to secured data in executing selected cryptographic processes, but further enhanced by leveraging predefined hardware interconnections (i.e., data channels) between port-specific resources and/or data allocations. The trusted communication matrix 314 can be implemented as a set of static hardware relays and/or logic, and/or dynamically implemented via reconfigurable hardware logic and/or relays. Accordingly, certain port-specific processes invoked by input data received via a particular port interface may be configured to depend from upstream cryptographic processes executed in respect of cryptographic data received on another hardware port and used to retrieve distinctly stored and maintained private data. Naturally, certain cryptographic processes may equally feed downstream processes executed in respect of a distinct port-specific data resource. Given the hardware implementation of the matrix 314, system security logic and complex data channeling can be hardwired into the HSM 300 and thus minimize external exposure to tampering. Given the above, it will be appreciated that while some ports 302 may be associated with corresponding storage resources 304 in a one-to-one fashion, other port interconnection scenarios may be invoked to logically associate a same port with distinct storage resources, as can distinct storage resources may be logically associated with a same hardware port. Likewise, additional hardware port interfaces may be defined to execute certain channel interconnection configurations without necessarily forming a direct link with any particular storage resource, for example.

As will be described in greater detail below, such variability and customizability may allow for the deployment and execution of different trusted hardware network interconnection solutions, such as for example, in linearly channeling port-specific data transactions between hardware ports in one or more one-to-one hardware port interconnection configurations (e.g. to provide (cryptographically) secure/trusted hardware-segregated port-specific processing paths), in consolidation/merging/multiplexing distinct data channels inbound via distinct hardware ports in a many-to-one configuration (e.g. to provide (cryptographically) secure/trusted data/transaction convergence processing paths), and/or in distributing and/or demultiplexing a single network source across multiple port-specific resources, services and/or data communication paths in parallel in a one-to-many configuration (e.g. to provide (cryptographically) secure/trusted data/transaction distribution/dissemination across multiple data channels from a trusted/reliable source).

In accordance with different illustrative embodiments, different non-limiting examples of single-chip hardware solutions may be considered. In some embodiments, a Xilinx's System on Chip (SoC) or Multi-Purpose SoC (MPSoC) product may be used, such as Zynq® and Zynq® UltraScale+™ respectively. The Zynq® product line is known to contain 2 ARM processors, memory components and Field Programmable Gate Array (FPGA) while the Zynq® UltraScale+™ has 6 ARM processors, memory components and FPGA. In a first exemplary embodiment, the Zynq® device may be used wherein one of the two ARM processors implements the cryptographic engine (CE) 310, a second ARM processor handles all memory accesses, and the FPGA implements the trusted communication matrix 314 between external communication ports and internal memory and cryptographic engine capability. In a second exemplary embodiment, the Zynq® UltraScale+™ is used wherein 5 of the 6 ARM processors are used as independent CEs while the sixth processor is used for handling all memory accesses and the FPGA implements the trusted communication matrix 314 between the external communication ports, internal memory and cryptographic engine capability. In a third exemplary embodiment, the Zynq® UltraScale+™ is used where all of the 6 ARM processors are utilized as independent CEs managing their own memory space and the FPGA implements the trusted communication matrix 314 between the external communication ports, internal memory and cryptographic engine capability. Other known and future technologies, hardware configurations and products may also be considered, as will be readily apparent to the skilled artisan, without departing from the general scope and nature of the present disclosure.

With continued reference to FIG. 3, in this embodiment, the matrix 314 may further invoke certain embedded channel resources 316 so to further enhance interconnection logic between ports and port-related processes, and thus allow for embedded security logic integration within the HSM's integrated hardware architecture. These channel resources 316 may be integrated and invoked in a one-to-one fashion, for instance, with integrated port specificity in fully maximizing secure process isolation, or again provided as a shared resource (one-to-many and/or many-to-one) that may be invoked and implemented for different port-specific processes albeit without exposing any such processes to undue external tampering risks.

In the illustrated embodiment, different channel resources are schematically illustrated to include any one or more of a data channel diode 318 (i.e. to restrict data flows on a defined channel to a designated direction), data channel filter 320 (i.e. to filter channel data, for example, to limit throughput data to a particular subset of retrieved data, or again to systematically reconfigure or replace designated data elements on a given channel data path), a channel comparator 322 (i.e. to invoke channel logic between channels based on a comparison of data being channeled thereon, for example, allowing process throughput only upon matching channel data), an inline encryption function 324 (e.g. to execute inline IPSEC or TLS protocol, for example, and/or to implement an inline VPN or like communication tunnel), or sniffer function (325).

For example, in some embodiments, an inline encryption function may be invoked to facilitate certain encrypted exchange with an end client or application that do not necessarily require access to the cryptographic engine and related higher security protocols. For instance, while critical private key management processes (e.g. control plane processes such as user/client authentication/authorization, authenticated session initiation and configuration, private key generation and management, system management functions, etc.) may be strictly relegated to the cryptographic engine and defined secure key spaces, less critical processes (e.g. communication plane processes, such as authenticated data access transactions, updates, edits, etc.,) for instance executed on the basis of a symmetric and/or ephemeral (e.g. session) key used to expedite processing and communications, may be implemented via the inline channel encryption resource 324. In so doing, the HSM 300 may integrally combine enhanced control plane cryptographic services, as described above, with inline cryptographic services, all within a same hardware design and configuration. This may, for example, readily allow for a singular hardware design, as described herein, to replace an otherwise common network (e.g. banking) architecture in which control plane functions and processes are traditionally relegated to a distinct network interfacing HSM, while session-based cryptographic functions are subsequently channeled through downstream network servers. The integrated configuration discussed herein may further, or alternatively, allow for the integrated execution of a virtual private network (VPN) or even nested VPNs to achieve a layered architecture within a single hardware design rather than to invoke a distributed network architecture in which security protocols are otherwise run on a higher network (e.g. TCP/IP) layer, and thus, more vulnerable to physical or external tampering.

As noted above, a sniffer or like function may also, or alternatively be deployed as an integrated and/or customizable channel resource, for instance, to provide a silent non-bypassable logging or network/channel tapping function to gain visibility on network channel communications. For instance, such channel resources may be non-obstructively used to monitor channel communications and raise a flag or alert upon identifying suspicious or anomalous channel activity, if not shutting down outright communications on this channel until remedial action can be taken.

As noted above, a trusted comparator or like function may be included to merge or otherwise compare data streams on respective hardware channels to increase a security and/or reliability thereof. Likewise, and as also noted above, a demultiplexing or multi-port distribution function (e.g. trusted function expander) may be implemented to securely distribute a same data stream or transaction across multiple hardware port-specific channels. For example, different applications may require for identical data to be distributed in parallel between data channels while ensuring an accuracy and reliability of the data source. Accordingly, by having such data originate or result from a secure process internal to the hardware interconnection device and/or integrated HSM, as described herein, secure replication and parallel distribution of such data across multiple embedded hardware data channels can be reliably executed.

Other channel resources may include, but are not limited to, a multi-port distribution function, gating function, a trusted metering function, a trusted controllable event counter, or the like. Further details and examples can be found, for example, in Applicant's U.S. Pat. No. 11,310,198 noted above. It will be appreciated that some or all, or again different channel resources may be integrated to provide different interconnection logic and functions between port-specific processes and thus enhance available internal process complexity and flexibility in providing a whole integrated solution, in some embodiments, embedded within a singular HSM chip implementation.

In this particular embodiment, the HSM 300 is further provided with optional external sensor monitors 326, for example, which may take the form of various sensors and/or monitors used to detect and report on system breaches or tampering. For example, sensors may include, but are not limited to, integrated sound sensors that may detect shell impacts or breaks; inclinometers or 3D accelerometers to detect displacement or physical reorientation of the shell (e.g. network module); smoke, heat and/or water sensors to detect environmental issues and/or tampering (e.g. multiple temperature sensors can be used to detect tampering via differential internal temperature metering); proximity or motion sensors to detect presence of unauthorized personnel; location or geofencing sensors to detect unauthorized transport of the HSM (module) beyond a designed security zone; and other such sensors as may be appreciated by the skilled artisan.

The HSM 300 may further include an administrator port 338 interface to allow for secured administrative access to the HSM 300 and allow for system maintenance and reconfiguration as may be required or desired from time to time. For example, where the HSM 300 is implemented as a reconfigurable chip (e.g. FPGA), certain hardware resources and/or logic may be re-allocated or reconfigured to address system or security protocol changes or improvements. For example, the trusted communication matrix may be adjusted to reflect new port allocations or leverage new or existing channel resources to further enhance security protocols, introduce new security levels or system integrations, or again refine existing protocols with improved processes and functions.

Using different aspects of the above-described embodiments, complex system architectures may be deployed on a single chip, as noted above, or again on a same integrated board design, i.e. where a module-embedded multi-port HSM can be integrated with the module's processing engine on a same or interconnected circuit board to deliver a complex (e.g. multi-purpose, multi-level, multi-tiered, multi-user, etc.) cryptographic service and system as a whole, all in some embodiments, within a same tamper-resistant shell.

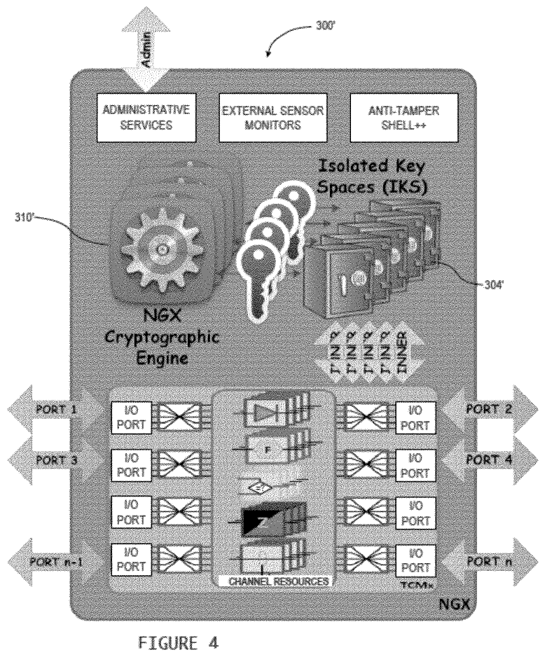

With reference to FIG. 4, and in accordance with yet another embodiment, an alternative HSM configuration 300′ is rather designed to define a respective cryptographic engine 310′ for each of the secured key spaces 304′. By replicating cryptographic resources, further hardware isolation (e.g., distinct firmware resources and/or firmware executed on distinct embedded processor cores) can be achieved in thus further enhancing the HSM's tamper resistance. Further alternatives should be readily apparent to the skilled artisan, and that, without departing from the general scope and nature of the present disclosure.

While the present disclosure describes various embodiments for illustrative purposes, such description is not intended to be limited to such embodiments. On the contrary, the applicant's teachings described and illustrated herein encompass various alternatives, modifications, and equivalents, without departing from the embodiments, the general scope of which is defined in the appended claims. Except to the extent necessary or inherent in the processes themselves, no particular order to steps or stages of methods or processes described in this disclosure is intended or implied. In many cases the order of process steps may be varied without changing the purpose, effect, or import of the methods described.

Information as herein shown and described in detail is fully capable of attaining the above-described object of the present disclosure, the presently preferred embodiment of the present disclosure, and is, thus, representative of the subject matter which is broadly contemplated by the present disclosure. The scope of the present disclosure fully encompasses other embodiments which may become apparent to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims. Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, as may be apparent to those of ordinary skill in the art, are also encompassed by the disclosure.

What is claimed is:

1. A modular network security system, comprising:
a cradle, dimensioned to define a plurality of juxtaposed network module slots, each comprising at a terminal end thereof, a cradle slot interface to an integrated cradle communication network;
a plurality of network modules dimensioned to mount juxtaposed within respective network module slots and each comprising a corresponding cradle network interface such that, when a given network module is mounted within a given network cradle slot, said corresponding cradle network interface physically engages said cradle slot interface thereby communicatively interfacing said given network module with said integrated cradle communication network;
wherein at least one of said network modules comprises a cryptographic processor hardwired therein to operatively interface with said corresponding cradle network interface to cryptographically secure communications between at least some of said modules over said integrated cradle communication network.

2. The modular network security system of claim 1, wherein said at least one of said network modules comprises a network module processing engine to execute a dedicated module-specific process, and wherein said cryptographic processor thereof operatively interfaces between said network module processing engine and said corresponding cradle network interface so to cryptographically secure said dedicated module-specific process from distinct network module processes.

3. The modular network security system of claim 1, wherein said at least one of said network modules comprises an external network interface and an external network module processing engine operable to execute an external network interfacing process that exchanges external network communications with said cryptographic processor for cryptographic processing prior to engagement with said integrated cradle network.

4. The modular network security system of any one of claims 1 to 3, wherein said integrated cradle network comprises a cradle agent operable to monitor operation of each of said network module via each said cradle slot interface.

5. The modular network security system of any one of claims 1 to 4, wherein upon mounting a new network module having a new cryptographic processor to interface with said integrated cradle network, said new cryptographic processor of said new network module is operable to communicate with said cryptographic processor of other network modules interfacing with said integrated cradle network to establish secure communications therewith.

6. The modular network security system of claim 5, wherein said secure communications are established with said new network module upon at least one of said other network modules cryptographically authenticating of said new network module.

7. The modular network security system of claim 5 or claim 6, wherein said new network module executes a cryptographic self-identification process with said other network modules.

8. The modular network security system of any one of claims 1 to 7, wherein each of said modules is further powered via said cradle slot interface

9. The modular network security system of any one of claims 1 to 8, wherein said cradle is configured to hold a horizontal stack of vertically oriented network modules, wherein said horizontal stack is dimensioned to correspond with 2 or more network rack units.

10. The modular network security system of claim 9, wherein said horizontal stack is dimensioned to correspond with 3 network rack units.

11. The module network security system of any one of claims 1 to 8, wherein said cradle is configured to hold a horizontal stack of juxtaposed horizontally oriented network modules, wherein said horizontal stack is dimensioned to correspond with one or more network rack units.

12. The module network security system of any one of claims 1 to 8, wherein said cradle is configured to hold a horizontal stack of vertically oriented network modules, and further hold one or more horizontally oriented network modules horizontally disposed above or below said horizontal stack.

13. The modular network of any one of claims 1 to 12, wherein said cradle is mountable to or within a communication network rack or cabinet.

14. The modular network security system of claim 1, wherein said plurality of network modules comprise distinct network module types respectively hardwired to provide, in operation, a distinct dedicated function, wherein, in combination, said plurality of network modules communicatively cooperate via said cradle communication network to perform a common network solution.

15. The modular network security system of claim 14, wherein said at least one of said network modules comprising said cryptographic processor defines a network security module, whereas at least one of said distinct network module types comprises a network module processing engine to execute a dedicated module-specific process that defines a network computation module that relies on implementation of said cryptographic processor from said network security module, via said integrated cradle communication network, to execute required cryptographic processes for said module-specific process.

16. The modular network security system of claim 1, wherein at least one of said network modules is hardwired to define a time synchronization module that comprises integrated therein a precision timing device and a given cryptographic processor operable to securely provide a digitally trusted time resource via said cradle network to at least another of said network modules.

17. The modular network security system of claim 1, wherein at least one of said network modules is hardwired to define a geo-positioning module that comprises integrated therein a Global Positioning System component and a given cryptographic processor operable to securely provide a digitally trusted geo-position to the modular network security system.

18. The modular network security system of claim 1, wherein said cryptographic processor is operatively couple to said at least one of said network modules via a hardware integrated PCIe card.

19. The modular network security system of claim 1, further comprising a management module having a management engine hardwired therein and a cradle network interface to operatively interface with said plurality of network modules via said cradle communication network.

20. The modular network security system of claim 19, wherein the system comprises two said management module each comprising an external network interface to respectively define a control plane and a data plane, while further defining a restricted plane for communications amongst said plurality of network modules via said cradle network.

21. A modular network security system, comprising:
a cradle, dimensioned to define a plurality of horizontally juxtaposed network module slots; and
a plurality of network modules dimensioned to mount horizontally juxtaposed within respective network module slots, at least two of said network modules comprising a network interface, an integrated processing engine, and an integrated cryptographic processor operable to execute a cryptographic process on communications exchanged with said integrated processing engine.

22. The modular network security system of claim 21, wherein said plurality of network modules, when mounted vertically oriented and horizontally juxtaposed within said cradle, are dimensioned to correspond with 2 or more network rack units.

23. The modular network security system of claim 22, wherein said plurality of network modules, when mounted vertically oriented and horizontally juxtaposed within said cradle, are dimensioned to correspond with 3 network rack units.

24. The modular network security system of any one of claims 21 to 23, wherein said cradle further comprises an integrated physical cradle network, and wherein each of said network modules is operable to digitally communicate with one another over said cradle network.

25. The module network security system of claim 24, wherein said network modules communicate cryptographically with one another over said cradle network via their respective cryptographic processor.

26. The modular network security system of claim 21, wherein at least one said integrated processing engine executes a network attached host process.

27. The modular network security system of any one of claims 1 to 26, wherein said cryptographic processor comprises a hardware security module.

28. A secure network module, comprising:
a housing mountable side-by-side juxtaposed horizontally with other corresponding network modules operatively mounted to a common server rack within a same rack unit;
a network interface operatively disposed on a front face of said housing to interface with an external network cable connector therein;
an integrated processing engine operatively mounted within said casing and interfacing via said network interface to process external network communications; and
an integrated cryptographic processor operatively mounted within said casing to interface with said integrated processing engine and execute a cryptographic process on internal communications exchanged with said integrated processing engine.

29. The secure network module of claim 28, wherein, when mounted vertically oriented to the common server rack, is dimensioned to correspond with 2 or more network rack units.

30. The secure network module of claim 29, wherein, when mounted vertically oriented to the common server rack, is dimensioned to correspond with 3 network rack units.

31. The secure network module of any one of claims 28 to 30, further comprising a rack network interface operatively disposed on a rear face of said housing to interface with a corresponding secure hardwired rack network when operatively mounted to digitally communicate with said other corresponding network modules.

32. The secure network module of claim 31, wherein said cryptographic processor is operable to communicate cryptographically with said other network modules over said secure hardwired rack network.

33. The secure network module of claim 28, wherein said integrated processing engine executes a network attached host process.

34. The secure network module of any one of claims 28 to 33, wherein said cryptographic processor comprises a hardware security module.

35. The secure network module of either one of claim 31 or claim 32, further comprising a GPS chip operatively hardwired to said processing engine and operable to provide a trusted location of the module and/or said other network modules.

36. The secure network module of either one of claim 31 or claim 32, further comprising a secure timing device operatively hardwired to said processing engine and operable to provide a trusted time for the module and/or said other network modules.

37. The secure network module of any one of claims 31 to 36, wherein said housing comprises a vertically mountable housing mountable in a vertical orientation.
